(19) United States
(12) Patent Application Publication
(10) Pub. No.: US 2025/0195187 A1
(43) Pub. Date: Jun. 19, 2025

(54) ORAL-JET PROCLEANING SYSTEMS

(71) Applicant: The University of Hong Kong, Hong Kong (CN)

(72) Inventors: Tze Chuen NG, Hong Kong (CN); Lijian JIN, Hong Kong (CN); James Kit Hon TSOI, Hong Kong (CN)

(73) Assignee: The University of Hong Kong, Hong Kong (CN)

(21) Appl. No.: 18/847,676

(22) PCT Filed: Mar. 8, 2023
(86) PCT No.: PCT/CN2023/080272

§ 371 Date: Sep. 16, 2024

Related U.S. Application Data
(60) Provisional application No. 63/320,619, filed on Mar. 16, 2022.

(51) Int. Cl. A61C 17/02

(52) U.S. Cl. CPC A61C 17/0202; A61C 2204/002

(57) ABSTRACT

A devices and systems for removing dental plaque/oral biofilms from a target surface or all surfaces of a tooth contains a socket head, a socket ball, and a pair of opposing bilateral wings. The socket ball is mounted in a joint-housing of the socket head, forming a ball-and-socket joint. The bilateral wings are connected to the socket head and extend downwardly. Each wing may include one or more cleaning elements, such as water cannons, water cannon folds, mega-/micro-nipples, and/or mega-/micro-nipple coupled water cannons. A system containing the device typically includes one or more additional components configured to incorporate the device into an element for user operation and link the device to a flow path, providing a fluid/air flow path for supplying a liquid and/or air to the device.

### CROSS-REFERENCE TO RELATED PATENT APPLICATIONS

This application is a U.S. National Stage Application under 35 U.S.C. § 371 of International Patent Application No. PCT/CN2023/080272, filed Mar. 8, 2023, and claims the benefit of priority under 35 U.S.C. Section 119 (e) of U.S. Application No. 63/320,619 filed Mar. 16, 2022, all of which are incorporated herein by reference in their entireties. The International Application was published in English on Sep. 21, 2023, as International Publication No. WO 2023/174120 A1.

### FIELD OF THE INVENTION

This invention is generally in the field of systems for oral cleaning, and more particularly, in the field of systems for removing dental plaque/oral biofilms from teeth.

### BACKGROUND OF THE INVENTION

Oral biofilms are the main cause for the most common oral diseases, such as dental caries (decay) and periodontal (gum) diseases. So it is of great importance for everyone to effectively control plaque biofilms daily (Jin et al., Oral Diseases, 22:609-619 (2016); Jepsen et al., Journal of Clinical Periodontology, 44 (Suppl. 18): S85-S93 (2017)).

Conventional and electric toothbrushes are the devices most utilized for controlling plaque biofilms, but they cannot adequately clean the inter-proximal areas of the teeth. To clean all surfaces of a tooth and the gingival or sub-gingival areas simultaneously, a toothbrush needs to be used in combination with another device, such as a water jet. A cavitating water jet allows for the removal of oral biofilms from the inter-proximal areas of the teeth, such as adjacent surfaces of natural teeth and dental implant fixtures (Jahn, Journal of Dental Hygiene, 84:114-120 (2010); Kato et al., Archives of Oral Biology, 57:30-35 (2012); Yamada et al., Implant Dentistry, 26:904-910 (2017); Agarwal et al., Biofouling, 30:359-365 (2014); Ijiri et al., International Journal of Lightweight Materials and Manufacture, 1:12-20 (2018)).

However, currently available oral jet cleaning systems, such as oral irrigators, generate a single jet at a high frequency, which can be uncomfortable for the user. Further, the water jet must be directed at the precise interproximal area to remove debris and/or plaque. Accurate human manipulation is needed to achieve effective disease preventing results. The high incidence of gum diseases in the general population proves that present systems are inadequate for effective control of plaque biofilms.

There remains a need to develop devices and systems capable of removing plaque biofilms effectively.

It is the object of the present invention to provide improved devices and systems for oral cleaning.

It is a further object of the present invention to provide methods of using the devices and system for oral cleaning.

### SUMMARY OF THE INVENTION

Devices (also referred herein as “Domes”) and systems for removing dental plaque/oral biofilms from a target surface or all surfaces of a tooth and their methods of using are described herein. The Dome described herein contains a socket head, a socket ball, and a pair of opposing bilateral wings.

The socket head contains two wing-connecting membranes and a top. The top contains at least one set of oppose sides and an opening located at or near the center of the top. The two wing-connecting membranes are bonded to the set of oppose sides of the top. The two wing-connecting membranes and the top can be formed as an integrated piece or separate pieces that attach to each other using a suitable method, such as thermal bonding or gluing. The wing-connecting membranes and top together form a joint housing.

The socket ball comprises a head portion and a connecting portion. The head portion is positioned inside the joint housing, and the connecting portion passes through the opening of the top, forming a ball-and-socket joint.

Each of the bilateral wings is bonded to the proximal end of one of the wing-connecting membranes via a connecting edge. Each of the wing-connecting membranes contains an inside surface and an outside surface, wherein a gap is positioned between a majority of the surface of the socket ball and the inside surface of each of the wing-connecting membranes. This gap allows the socket ball to rotate inside the joint housing and also allows for the proper delivery of liquid and/or air to a target surface or all surfaces of a target tooth for cleaning. Each of the bilateral wings extends downwardly from the wing-connecting membrane to which it is bonded. An open region is located in a joining area that joins each of the bilateral wings and the wing-connecting membrane to which it is bonded. The open region is configured to allow movement of the wing.

Each of the bilateral wings contains a cleaning membrane, a base portion, and two side portions. The base portion is connected to the cleaning membrane via a bottom edge and the side portions are connected to the cleaning membrane via a pair of opposite side edges. The cleaning membrane of each of the bilateral wings contains an inside surface and an outside surface, wherein the outside surfaces of the cleaning membranes have a curvature such that the bilateral wings enclose each target tooth when in use. The inside surface of the cleaning membrane contains a vertical plane, optionally two or more vertical planes aligned side-by-side. The vertical plane, optionally each vertical plane of the two or more vertical planes, has a curvature that conforms to the external curvature of one or more types of teeth. Each of the base portion and two side portions of the wing has a curved shape such that is rolls away from the periodontal tissues when in use.

One or both of the bilateral wings can contain a cleaning element, optionally two or more cleaning elements, incorporated on the inside surface of the cleaning membrane and/or at a base of the cleaning membrane. The cleaning element, optionally each cleaning element of the two or more cleaning elements, can be a plurality of water cannons, a water cannon fold or two or more water cannon folds, a plurality of mega-nipples, a plurality of micro-nipples, or a plurality of water cannons coupled with mega-or micro-nipple heads.

Typically, each water cannon of the plurality of water cannons contains a hollow gun barrel. The hollow gun barrel can be embedded in the inside surface of the cleaning membrane, creating an opening thereon. Each water cannon of the plurality of water cannons can be positioned such that it is perpendicular to the external curvature of a target tooth. The hollow gun barrel can have any suitable shape, for example, a tapered cylindrical shape.

The water cannon fold or each water cannon fold of the two or more water cannon folds incorporated on the inside surface of the cleaning membrane and/or at the base of the cleaning membrane can contain a continuous channel along the bottom edge of the cleaning membrane. The channel has an opening positioned at an angle pointing at the periodontal pocket and a depth sufficient to trap liquid/air and/or bubbles when in use. When two or more water cannon folds are incorporated in the cleaning membrane, they can be arranged in parallel with each other with a suitable distance in between neighboring water cannon folds.

The mega-/micro-nipple of the plurality of mega-/micro-nipples is a protrusion from the inside surface of the cleaning membrane. The mega-or micro-nipple can have any suitable shape and size, such as a semi-spherical shape, as long as it does not have a sharp point or edge that may damage the surfaces of the teeth. Generally, each mega-nipple of the plurality of mega-nipples can have a diameter in a range from >1 mm to about 5 mm, from about 1.2 mm to about 5 mm, from about 1.5 mm to about 3 mm, such as about 1.5 mm, from about 0.5 mm to about 1 mm, or from about 1 mm to about 2 mm. Each micro-nipple of the plurality of micro-nipples can have a diameter in a range from about 0.1 mm to about 1 mm, from about 0.1 mm to about 0.8 mm, or from about 0.2 mm to about 0.6 mm, such as about 0.5 mm.

Systems for removing dental plaque/oral biofilms from a target surface or all surfaces of a tooth are also disclosed. Generally, the system includes a Dome described herein, a conduit, and a hand unit. The hand unit contains a channel and two opposing ends. The dome is attached to one of the opposing ends of the hand unit via the conduit, such that the channel of the hand unit is in fluid communication with a liquid and/or air source and is in fluid communication with the conduit and the dome. The dome can be integral with or detachably attached to the conduit. Alternatively, or additionally, the conduit can be integral with or detachably attached to the hand unit. The hand unit can further contain an ultrasonication vibrator, a circuit board, or a control, or a combination thereof. Optionally, the hand unit can also contain a chamber for a rechargeable battery or disposable battery, gripping structures, an output display, or an audio component, or a combination thereof.

The system can further include a base unit. The base unit includes a tank and a tube. The other opposing end of the hand unit (i.e. the opposing end that is not attached to the conduit) can be connected to the tank via the tube such that the channel of the hand unit is in fluid communication with a liquid inside the tank. The base unit can further include an air channel configured to be in fluid communication with the channel of the hand unit via the tube. The base unit may further include a motor and a pump, and optionally a pressure regulator, a power switch, a charging port, a tubing storage element, a stand for holding an additional conduit, and/or a water feeding element. In some forms, the base unit may include a power port, or a power cord configured to connect the system to an external power source. The tank included in the base unit has a body defined by a wall or two or more walls, and a lid. The lid of the tank can be integral with or detachably attached to the body. In some forms, the tank can further contain a drug inert port configured to allow the addition of a drug tablet or a drug solution into the tank. The drug inert port may be located anywhere on the tank, for example, on the lid of the tank.

Methods for oral cleaning in a subject in need thereof using the Dome and systems described herein are also disclosed. Generally, the method includes (i) moving the Dome along the dental arch of the subject. During step (i) liquid and/or air are ejected through an outlet of the socket ball of the Dome at a pressure in a range from about 0.5 psi to about 30 psi, at a pulse frequency in a range from about 0.5 Hz to about 50 Hz, and/or at a delivery pulse volume in a range from about 0.1 mL to about 150 mL. In some forms, the method further includes providing an ultrasonic vibration to the Dome prior to and/or during step (i). The ultrasonic vibration can have a frequency in a range from about 100 to about 5000 vibrations per second, from about 500 to about 4000 vibrations per second, or from about 1000 to about 3000 vibrations per second.

In some forms, the method for oral cleaning disclosed herein further includes one or more optional steps, such as attaching the Dome onto the conduit and/or hand unit prior to step (i); placing the Dome over a tooth of the subject prior to step (i); activating the power of the hand unit prior to or subsequent to step (i); selecting or adjusting the power output, duration of cleaning, frequency of ultrasonic vibration, and/or duration of ultrasonic vibration prior to or during step (i); maintaining the Dome over a target tooth for a period of time; switching between liquid and air during step (i); and/or rinsing a patient's mouth with a mouthwash prior to and/or subsequent to step (i).

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIGS. 1A and-1B depict different views of an exemplary dome 100 where FIG. 1A depicts a top view of the exemplary dome 100 and FIG. 1B depicts a bottom view of the exemplary dome, FIGS. 1C-1F depict different views of another exemplary dome 100″, FIG. 1C depicts a top view of the exemplary dome 100″, FIG. 1D depicts a bottom view of the exemplary dome 100″, FIG. 1E depicts a cross-sectional view of the exemplary dome 100″and FIG. 1F depicts a side view of the exemplary dome 100″;

FIGS. 2A and 2B depict the cross-sectional views of the exemplary dome depicted in FIGS. 1A and 1B where FIG. 2A depicts the bilateral wings of the dome accommodating the front teeth (incisors and canines) and FIG. 2B depicts the bilateral wings of the dome accommodating the premolars and molars;

FIGS. 3A-3D depict different views of one of the wings of the exemplary dome depicted in FIGS. 1A-1C, where FIG. 3A depicts a perspective view of the wing with two vertical geometrical curvatures to accommodate the different surface curvatures for different forms of teeth in humans including incisors/canines and/or premolars/molars, FIG. 3B depicts a side view of the wing showing the curvature in parallel with the surface of premolar/molar, FIG. 3C depicts a side view of the wing showing the curvature in parallel with the buccal surface of incisor/canine and FIG. 3D depicts a side view of the wing showing the curvature in parallel with the lingual surface of incisor/canine;

FIG. 4 depicts a cross-sectional view of the wing depicted in FIG. 3A, showing the curvature-guided water and bubble flushing from the top through micro-gap interface, thereby precisely targeting the gingival sulcus (sub-gumline niches) and/or periodontal pocket as the terminal destiny;

FIGS. 5A-5D depict different views of one of the wings of the exemplary dome depicted in FIGS. 1A-1C, showing the curvatures of a left side portion, a right-side portion, and a base portion of the wing wherein FIG. 5A depicts a side view of the curvature of the base portion, FIG. 5B depicts a perspective view of the curvature of the base portion, FIG. 5C depicts a partial side view of the curvature of the base portion and FIG. 5D depicts a partial bottom view of the curvature of a side portion;

FIGS. 6A-6C depict side views of an exemplary wing having micro water cannons distributed on the base of the wing where FIG. 6A depicts a side view of the wing having micro water cannons distributed on the curvature in parallel with the surface of premolar/molar, FIG. 6B depicts a side view of the wing having micro water cannons distributed on the curvature in parallel with the buccal surface of incisor/canine and FIG. 6C depicts a side view of the wing having micro water cannons distributed on the curvature in parallel with the lingual surface of incisor/canine;

FIG. 7A depicts a perspective view of an exemplary micro water cannon with nipple head protruded slightly above the panel surface and gun barrels distributed under the geometry with an opening and FIGS. 7B-7D depict perspective views of an exemplary cleaning membrane incorporating mega-nipple/water cannon in FIG. 7B that generates cavitation force, wherein FIG. 7C indicates water cannon force, and FIG. 7D indicates tsunami force (FIG. 7D), while FIG. 7E depicts a cross-sectional view of a plurality of micro-nipples on the curvature of the wing;

FIG. 8 depicts a cross-sectional view of an exemplary wing with a water cannon fold;

FIG. 9A depicts a perspective view of one wing of an exemplary Dome having multiple layers of water cannon folds pointing towards the lingual side surface of a tooth, at a gum-tooth interface, or a gum-implant interface and FIG. 9B depicts a cross-sectional view of two bilateral wings of the exemplary Dome depicted in FIG. 9A;

FIG. 10A depicts a perspective view of one wing of an exemplary Dome having a plurality of micro-nipples incorporated on the inside surface of the cleaning membrane and FIG. 10B depicts a cross-sectional view of two bilateral wings of the exemplary Dome depicted in FIG. 10A;

FIGS. 11A-11C depict cross-sectional views of domes having different features wherein FIG. 11A depicts a cross-sectional view of a dome having a plurality of micro-nipples and a water cannon fold on the wing, FIG. 11B depicts a cross-sectional view of a dome having a plurality of mega-nipples and a water cannon fold on the wing and FIG. 11C depicts a cross-sectional view of a dome having a plurality of water cannons with mega-nipple heads and a water cannon fold on the wing;

FIG. 12 depicts a schematic diagram of an exemplary oral jet cleaning system; and

FIG. 13A depicts a side view of an exemplary oral jet cleaning system, FIG. 13B depicts a side view of an exemplary handle unit with a dome attached thereto and FIG. 13C depicts a side view of an exemplary handle unit.

### DETAILED DESCRPTION OF THE INVENTION

### I. Devices and Systems

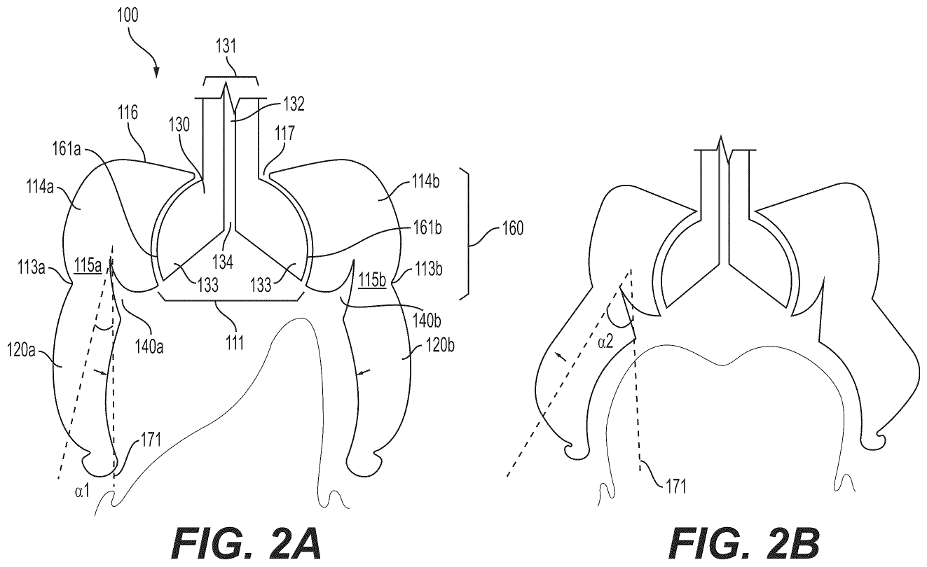

Devices capable of removing dental plaque/oral biofilms from a target surface or all surfaces of a tooth (e.g., labial/buccal, lingual, inter-dental space, gingival sulcus, and/or periodontal pocket) have been developed. The device described herein is a dome-shaped cleaning device (also referred to herein as the “Dome”). The Dome 100 is designed such that when in use, a variety of forces are generated by a high-speed water jet coupled with an ultrasonic wave or vibration targeting a specific surface or all surfaces of a tooth enclosed by the Dome. FIG. 2B This allows efficient removal of dental plaque/oral biofilms, thereby preventing oral/periodontal (gum) diseases and improving oral/periodontal health care by reducing the oral biomass load of oral/periodontal pathogens and/or levels of oral/periodontal inflammation.

### A. Dome

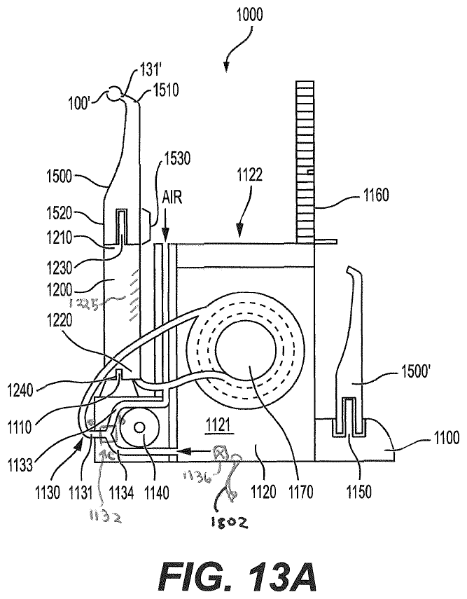

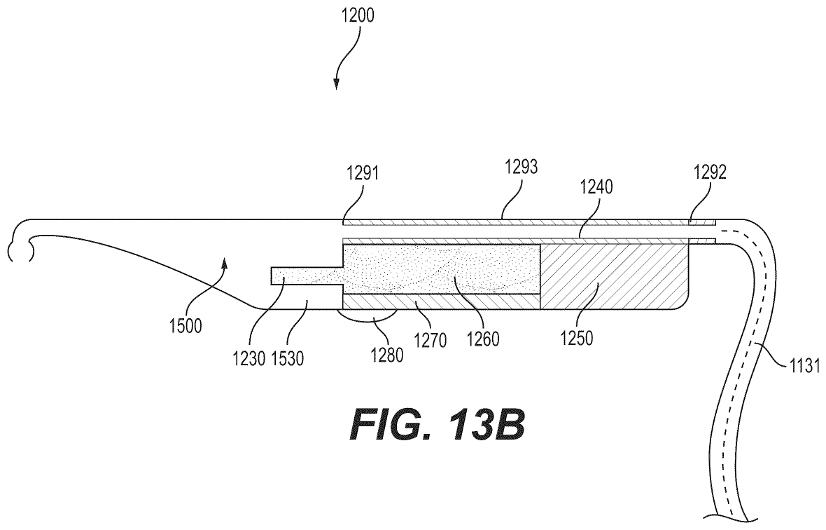

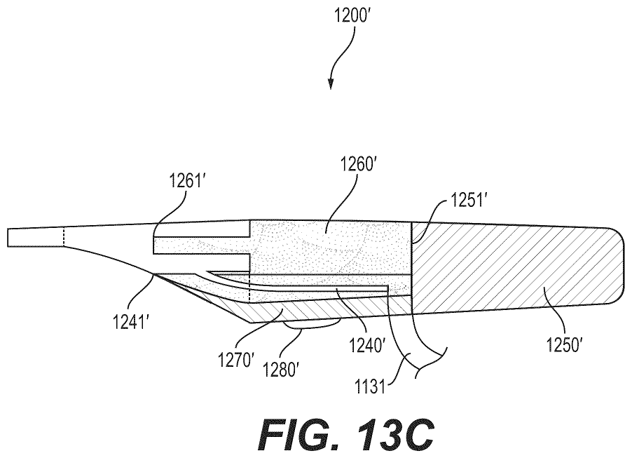

The Dome 100 can be detachably connected to a hand unit 1200 via a conduit 1500 or incorporated into a system via the hand unit 1200 for oral cleaning. FIG. 13A Specifically, the user can hold the hand unit having a Dome operably connected thereto and move the Dome along the dental arch and detach biofilms on each tooth by one or more of the following forces generated by the Dome: (1) water cavitation microbubble suctioning force, (2) ultrasonic vibratory tsunami force, and (3) micro-water-Jet force. These forces can minimize abrasion to the tooth surfaces caused by conventional bristles of toothbrushes and maximize biofilm removal. The term “operably connected” refers to a direct connection or an indirect connection between the Dome and the hand unit.

### 1. Components

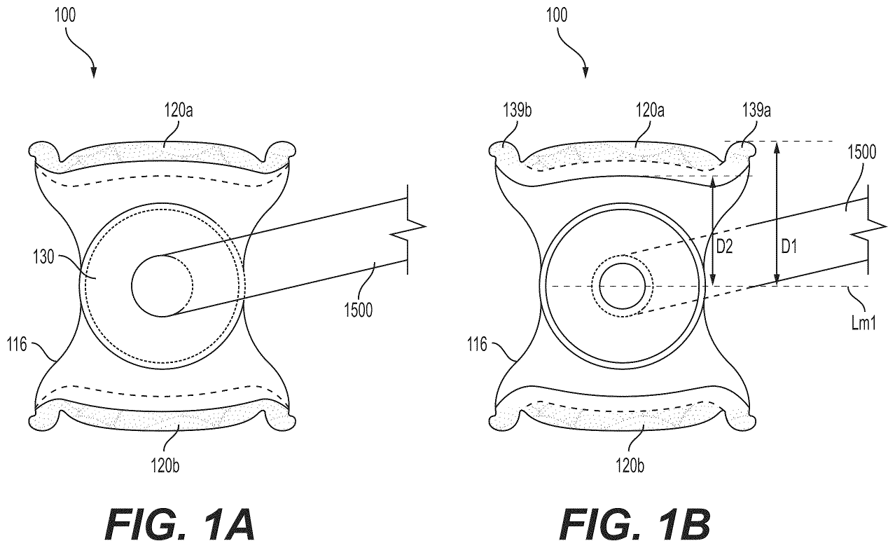

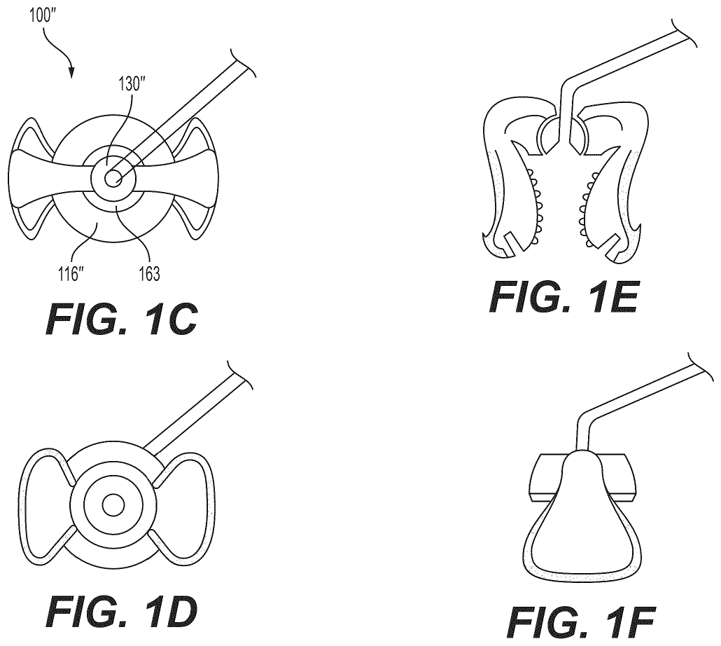

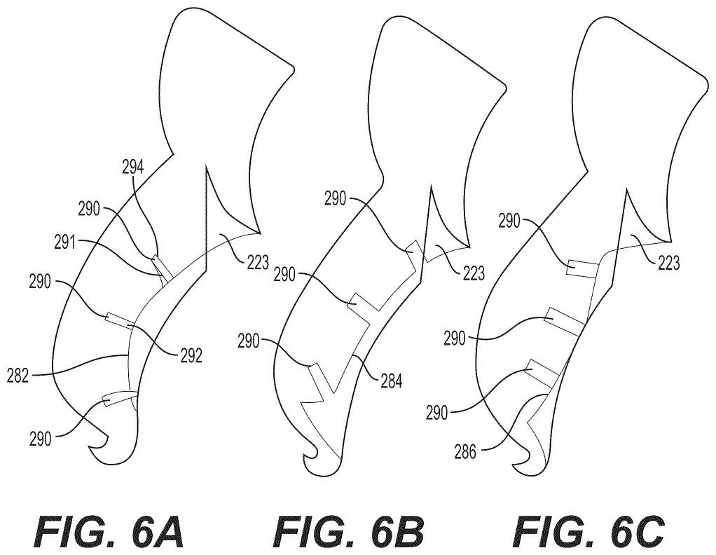

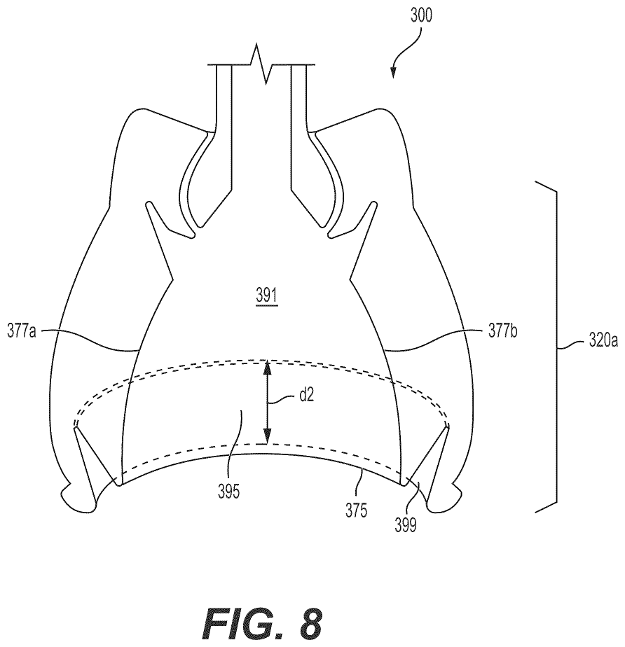

Typically, the Dome 100 includes a socket head 110, a socket ball 130, and a pair of opposing bilateral wings 120a, 120b. The socket ball is mounted in a joint housing 111 of the socket head, forming a ball-and-socket joint. FIG. 1A and 2A The bilateral wings are connected to the socket head. Optionally, each wing of the dome includes one or more cleaning elements, such as a plurality of water cannons 290, one or more water cannon folds 395, a plurality of mega-/micro-nipples, or a plurality of mega-micro-nipple coupled water cannons, or a combination thereof. FIGS. 6A-6C and FIG. 8.

a. Socket Head and Socket Ball

The socket head includes two wing-connecting membranes 114a, 114b, and a top 116, together forming a joint housing 111. The joint housing has a suitable shape and dimensions such that it accommodates the socket ball 130, allowing the socket ball to rotate in the joint housing. The two wing-connecting membranes are on a set of opposite sides of the top. The top contains an opening located 117 at or near the center of the top. The opening is a shaped hole, such as a circular, a D-shaped, a star-shaped, an oval-shaped, or a tooth-shaped hole, which is configured to mate with a connecting portion of the socket ball. In use, the ball and socket joint can tilt according to the position of a target tooth to which the dome is to be coupled.

The socket ball has a head portion and a connecting portion 130′. The head portion of the socket ball is positioned inside the joint housing 111 with the connecting portion passing through the opening 117 on the top for connecting with a conduit for delivering liquid/air, forming a ball-and-socket joint (also referred to herein as a “spheroidal joint”). The connecting portion can have any suitable shape and dimensions, as long as it corresponds with the shape and dimension of the opening on the top of the socket head such that it is able to pass through the opening and connect to the conduit. A gap 161a, 161b is positioned between a majority of the surface area of the socket ball 130 and the inside surface of each wing-connecting membrane 114a, 114b to allow movement of the socket ball and/or the wing-connecting membranes, such that the socket ball can rotate inside the joint housing and allow proper delivery of liquid/air to a target surface or all surfaces of a target tooth 200 for cleaning. For example, the head portion of the socket ball can be positioned to tilt towards the inner surface of one of the bilateral wings and, at an angle relative to the center axis of the Dome. The angle may be approximately 0 to 60degrees, approximately 0 to 50 degrees, approximately 0 to 40 degrees, or approximately 0 to 30 degrees, such as approximately 30 degrees, depending on the position of a target surface of a target tooth.

The socket ball contains a liquid/air channel 132 running through a center axis of the socket ball which terminates with an outlet 134. The liquid/air channel is in fluid communication with the conduit, such that water and/or air is provided to the liquid/air channel through the conduit and is then flushed to a target surface or all surfaces of a target tooth (e.g. labial/buccal, lingual, inter-dental space, gingival sulcus, and/or periodontal pocket) through the outlet 134. The conduit can be any appropriate means, rigid or flexible, for conveying liquid/air from a liquid/air source and to the Dome, such as a hollow object having a suitable shape, a tube, a channel, a pipe, etc. The conduit can be configured such that it bends at a location near the socket ball. Such a configuration allows a user can easily place the Dome into his/her mouth for cleaning.

b. Bilateral Wings

Each of the bilateral wings 120a, 120b of the Dome is bonded to the proximal end of one of the wing-connecting membranes 114a, 114b (also referred to herein as the “corresponding wing-connecting membranes”) by a suitable technique, such as thermal bonding. Alternatively, a pair of one wing and its corresponding wing-connecting membrane is a unitary piece (i.e. a one-piece structure), for example formed by molding, 3D printing, or integral casting. Each of the bilateral wings extends downwardly from its corresponding wing-connecting membrane.

An open region 140a, 140b is located in a joining area that joins each wing and its corresponding wing-connecting membrane. The open region is configured to allow movement of the wing, such that the angle between an imaginary vertical measuring line (see, e.g. FIGS. 2A and 2B, 171) and each of the wings can vary during ultrasonic vibration and/or to accommodate teeth of different sizes. For example, as shown in FIG. 2A and 2B, each of the bilateral wings 120a and 120b forms a first angle α1 with the imaginary vertical measuring line 171 (which aligns with the central vertical axis of the socket ball) to accommodate the incisors and/or canines (FIG. 2A) and forms a second angle α2 with the imaginary vertical measuring line 171 to accommodate the premolars and/or molars (FIG. 2B). The second angle α2 is larger than the first angle α1 due to the larger width of premolars and molars compared to incisors and canines. The open region can have any suitable shape and dimensions, such as a triangle, rectangle, a square, a trapezoid, a cut line, etc., as long as it is positioned in the joining area and allows for movement of the wing.

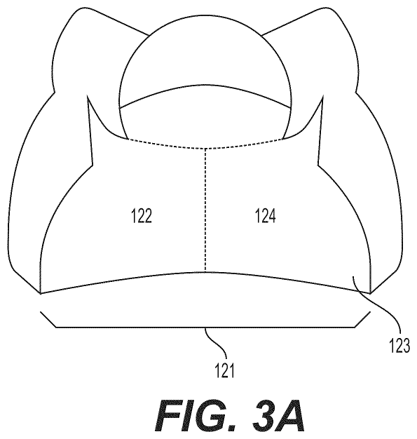

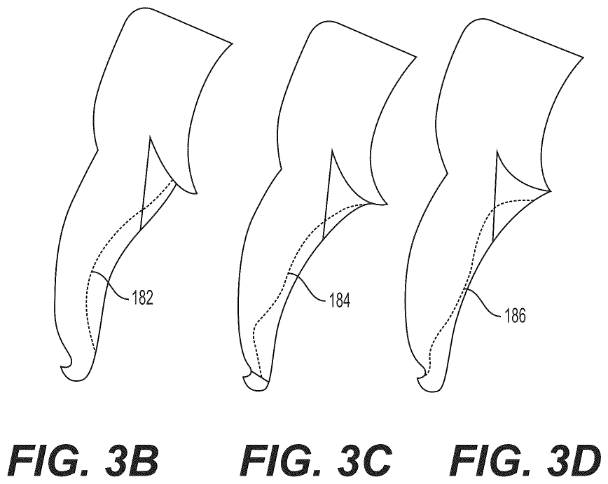

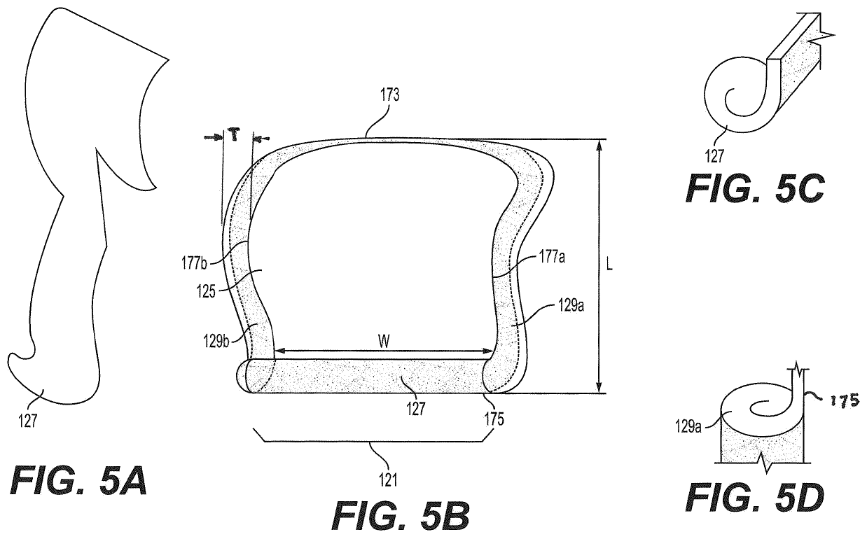

Each of the bilateral wings contains a cleaning membrane 121 having an inside surface 123 and an outside surface 125, a base portion 127, and two side portions 129a, 129b (see, e.g. FIGS. 3A and 5B). The base portion is connected to the cleaning membrane via a bottom edge 175; the side portions 129a, 129b are connected to the cleaning membrane 121 via a pair of opposite side edges 177a, 177b; and the cleaning membrane is connected to the wing-connecting membrane of the socket head via a connecting edge 173. The connecting edge, bottom edge, and two side edges define a length (L) and a width (W) of each wing. For example, as shown in FIG. 5B, the length, L, is measured from the connecting edge 173 to the bottom edge 175 and the width, W, is measured from a first side edge 177a to a second side edge 177b. The length (L) and width (W) of each wing are sufficient to cover the labial/buccal and lingual surfaces of a tooth. For example, each of the two wings has a length (L) in a range from about 10 mm to about 20 mm, optionally from about 10 mm to about 18 mm or from about 10 mm to about 16 mm, for example about 11 mm, and a width (W) in a range from about 5 mm to about 25 mm, optionally from about 5 mm to about 20 mm, from about 10 mm to about 20 mm, or from about 5 mm to about 8 mm, for example about 6 mm or about 18 mm. The distance between the bottom edges of the bilateral wings can be in a range from about 5mm to about 25 mm, from about 5 mm to about 20 mm, from about 5 mm to 15 mm, or from about 5 mm to 10 mm. By way of examples, the exemplary Dome 100 shown in FIG. 3A has a wing length (L) of about 11 mm and a wing width (W) of about 11 mm, both of which can be modified to be in any of the ranges described above. For example, although not shown, the exemplary Dome 100 can be modified to be larger, such as having a wing length (L) in a range from 11 mm to 22 mm, about 11 mm, about 18 mm, or about 22 mm, and a wing width (W) in a range from 10 mm to about 22 mm, about 11 mm, about 18 mm, or about 22 mm. Alternatively the Dome can be modified to be smaller, such as having a wing length (L) in a range from 10 mm to 15 mm and a wing width (W) in a range from about 4 mm to about 5 mm. The largest distance in between the inside surface 123 and outside surface 125 of the cleaning membrane defines a thickness (T) of the wing (see, e.g. FIG. 5B-5D). The thickness, T, is typically sufficient to incorporate one or more cleaning elements on the inside surface, as described in detail below. For example, each of the bilateral wings has a thickness in a range from 1 mm to 5 mm, from 2 mm to 5 mm, from 2 mm to 4 mm, such as from 3 mm to 4 mm.

i. Curvature

The outside surface 125 of each cleaning membrane 121 of the wing has a curvature such that the two wings enclose each target tooth. Typically, the outside surface is smooth to minimize discomfort during cleaning. Generally, the wing has a thickness sufficient to accommodate the mirror image of the tooth surface, to allow sufficient wing movement during operation.

The inside surface 123 of each cleaning membrane 121 contains at least one vertical plane, optionally two vertical panels aligned side-by-side (see, e.g. FIG. 3A, 122, 124). Each panel contains a curvature that conforms to the external curvature of one type of teeth (e.g. premolar/molar or incisor/canine). For example, as shown in FIGS. 3A-3D, each of panels 122 and 124 contains a curvature 182 that conforms to the external curvature of premolar/molar; a curvature 184 that conforms to the buccal curvature of incisor/canine; and/or a curvature 186 that conforms to the lingual curvature of incisor/canine. The dotted lines shown in FIGS. 3B-3D illustrate the different curvatures on the inside surface of the cleaning membrane from the side that conforms to the external curvature of premolar/molar (FIG. 3B), the buccal curvature of incisor/canine (FIG. 3C), and the lingual curvature of incisor/canine (FIG. 3D), respectively.

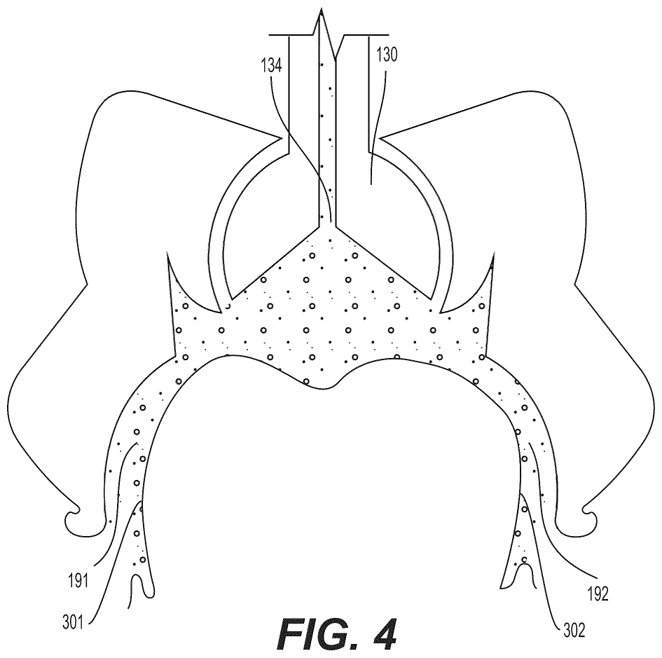

The different curvatures incorporated on the inside surface of each cleaning membrane allow the bilateral wings to conform to the different curvatures for some or all types of teeth in human. When the Dome is moved along the dental arch, at least one panel on each wing containing a curvature that conforms to the buccal/labile and lingual curvatures of each tooth. As shown in FIG. 4, when in use, water and bubbles are flushed out from the outlet 134 of the socket ball, creating two interface micro-gaps: a first interface micro-gap 191 between the labial/buccal surface of a tooth being treated (also referred to herein as “target tooth”) and its corresponding curvature on the inside surface of the cleaning membrane (see, e.g. FIG. 4), and a second interface micro-gap 192 between the lingual surface of the tooth and its corresponding curvature on the inside surface of the cleaning membrane (see, e.g. FIG. 4). The “corresponding curvature” refers to the curvature on the inside surface of the cleaning membrane that conforms to an external surface (labial/buccal or lingual) of the target tooth.

The interface micro-gaps 191, 192 in between the external surfaces of the target tooth and their corresponding curvatures of the wing can guide the liquid/air and/or bubbles to flush through these micro-gaps creating hydrofoil effect, and towards the tomography of gingival sulcus (e.g. sub-gumline niches) and/or periodontal pocket, to detach and flush out the oral biofilms. Optionally, when an ultrasonic vibration is applied, these micro-gaps also allow the ultrasonic vibration wave being emitted in a vertical direction towards the surfaces of the target tooth to detach the oral biofilms. Each tooth is treated in turn as the Dome moves from the back molar on the left to the back molar on the right along the dental arch.

ii. Side and Base Portions

The base portion 127 of each wing is connected to the cleaning membrane 121 via the bottom edge 175, running from a first side edge to an opposite second side edge along the entire width of the wing (see, e.g. FIG. 5B, 127). Each of the side portions 129a, 129b is connected to the cleaning membrane of the wing via the first or second side edge 177a, 177b (see, e.g. FIG. 5B). Each of the base portion and two side portions of the wing has a curved shape such that it rolls away from the periodontal tissues to minimize any traumatic effect to the periodontal tissues as the Dome moves along the dental arch. For example, as shown in FIG. 5A, instead of pointing to and creating a sharp contact edge with the periodontal tissue when in use (the dotted lines), the base portion 127 of the wing has an OMEGA shape (the solid lines) that rolls outwardly from the periodontal tissues and provides a smooth contact edge with the periodontal tissue. As shown in FIG. 5C, the OMEGA-shaped base portion 127 rolls outwardly and upwardly from the bottom edge 175 connecting the cleaning membrane 121 (not visible in FIG. 5C). For example, as shown in FIGS. 1A and 1B, each of the two side portions 129a and 129b on each wing rolls outwardly and inwardly from the side edge 177a or 177b via which it connects to the cleaning membrane 121. The distal end (i.e. 139a or 139b) of each side portion is located at a distance D1 (measured from an imaginary horizontal measuring line Lm1 through the center of the opening 117) that is larger than a distance D2 (measured from the horizontal imaginary measuring line Lm1 to the inside surface of the cleaning membrane 121), such that the side edges of each wing do not contact the periodontal tissue with any sharp point.

Each of the base portion and two side portions of the wing can have other curved shapes, as long as they avoid touching the periodontal tissues with any sharp contacts.

c. Cleaning Elements

Optionally, one wing or both wings of the Dome contain(s) one or more cleaning elements incorporated on the inside surface 123 of the cleaning membrane(s) 121. Examples of cleaning elements include, but are not limited to, a plurality of water cannons 290, one or more water cannon folds 395, a plurality of mega-/micro-nipples, and a plurality of water cannons coupled with mega-or micro-nipple heads, and a combination thereof. FIG. 6A-6C and FIG. 8.

i. Water Cannon

A plurality of water cannons 290 may be incorporated on the inside surface of the cleaning membrane(s) of one wing or both wings of the Dome. Optionally, a plurality of water cannons is incorporated on the inside surface of the cleaning membrane of one wing of the Dome. Optionally, a plurality of water cannons is incorporated on the inside surfaces of the cleaning membranes of both bilateral wings of the Dome.

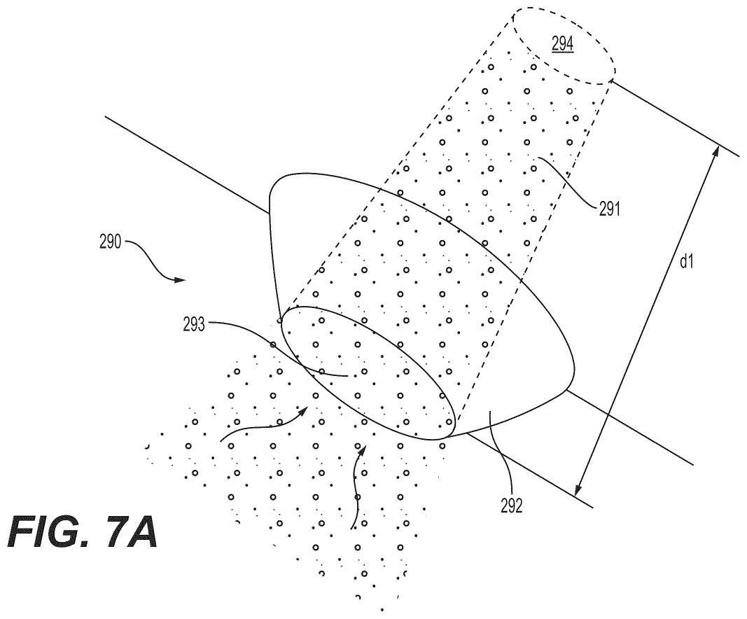

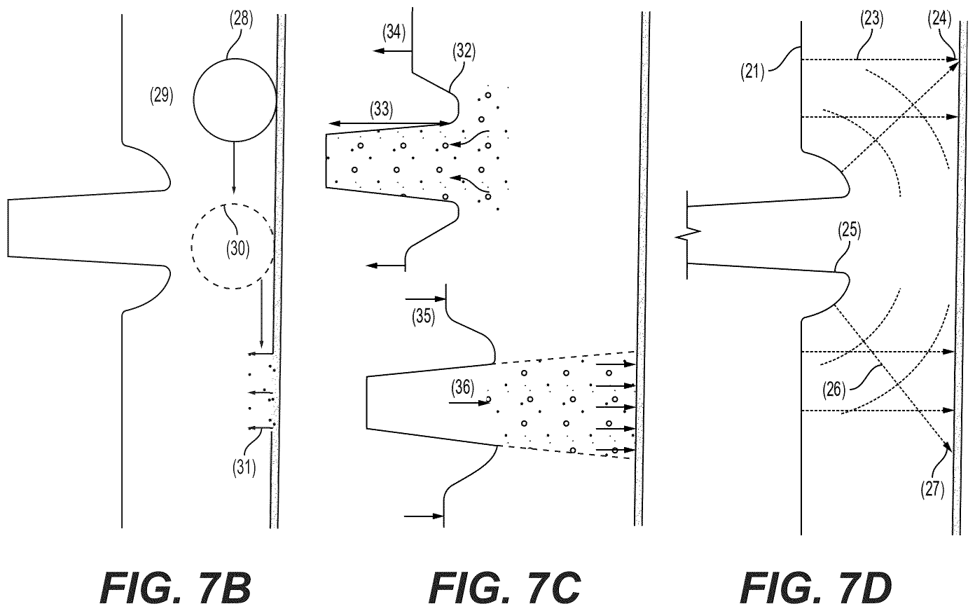

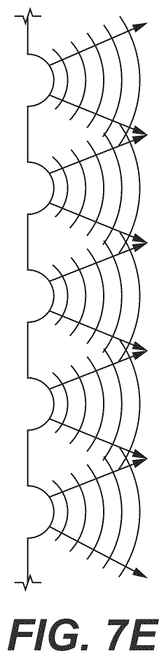

A water cannon 290 contains a hollow gun barrel 291 embedded in the inside surface of the cleaning membrane, creating an opening thereon. FIG. 7A The hollow gun barrel is positioned perpendicular to a corresponding curvature such that it is also perpendicular to the external curvature of a target tooth, such as the external curvature of premolar/molar, the labile surface of premolar/molar, or the lingual surface of incisors/canine. The gun barrel can trap liquid/air and/or bubbles that flush through the interface micro-gap and eject the trapped liquid/air and/or bubbles towards the external surfaces of a target tooth upon application of an ultrasonic vibration.

The hollow gun barrel 291 of the water cannon 290 can have any suitable shape and dimensions, as long as it has a sufficient volume to trap the flushing liquid/air and/or bubbles. For example, the gun barrel can have any regular shape, such as that of a sphere, cylinder, cone, cube, diamond, half sphere, pyramid, triangular prism, hexagonal prism, star, cuboid, tetrahedron, trapezoid, etc. or an irregular shape. Preferably, the gun barrel has a tapered cylindrical geometry. The hollow gun barrel has a depth (d1) measured from the opening of the water cannon to the bottom of the gun barrel (see, e.g. FIG. 7A, d1). The depth (d1) of the gun barrel can be adjusted to achieve a desired force, ejecting distance, and direction for a target tooth. For example, the depth (d1) of the gun barrel is in a range from about 0.1 mm to about 5 cm, from about 1 mm to about 4 cm, or from about 2 mm to about 3 mm. The gun barrel or each gun barrel incorporated on the inside surface of the cleaning membrane can have a diameter in the range from 1 mm to 3 mm.

The opening 293 of the water cannon can have any geometry and dimensions, as long as it allows the trapped liquid/air and/or bubbles to be ejected out of the gun barrel. Exemplary geometries of the opening include, but are not limited to, circular, elliptical, trapezoidal, square, rectangular, triangular, star, diamond, oval, heart, polygonal, cross, half circular, etc. and irregular geometries. For example, the opening of the water cannon has a circular geometry having a diameter in a range from about 0.1 mm to about 10 mm, from about 1 mm to about 8 mm, from about 2 mm to about 5 mm, or from about 2 mm to about 3 mm.

The cleaning membrane 121 can contain water cannons of the same shape having the same or different dimensions, or water cannons of different shapes and dimensions. When both cleaning membranes contain a plurality of water cannons incorporated thereon, the first cleaning membrane can have water cannons of the same shape having the same or different dimensions as the second cleaning membrane, or water cannons of different shapes and dimensions from the second cleaning membrane.

ii. Water Cannon Fold

One or more water cannon fold(s) 395 may be incorporated on the inside surface or at the base of the cleaning membrane(s) of one wing or both wings of the Dome. FIGS. 8. Optionally, one water cannon fold 395 is incorporated in the inside surface of the cleaning membrane of one wing (see, e.g. FIG. 8) or each cleaning membrane of the bilateral wings. The water canon fold is a continuous channel positioned above and along the bottom edge of a wing. The channel can have any suitable shape, such as a tapered cylindrical shape, a trapezoidal shape, a conical shape, a half-cylindrical shape, a half-spherical shape, etc. The water canon fold runs from a first side edge to an opposite second side edge of wing. The water canon fold has an opening positioned at an angle pointing at the periodontal pocket, and a depth (d2) measured from the opening 399 to the bottom of the channel (see, e.g. FIG. 8). The depth (d2) of the water cannon fold is sufficient to trap liquid/air and/or bubbles, such that with an applied ultrasonic vibration, the water cannon fold can trap liquid/air and/or bubbles and subsequently eject the trapped liquid/air and/or bubbles towards the gingival sulcus and/or the periodontal pocket. The depth (d2) of the water cannon fold can be adjusted to achieve a desired force, ejecting distance, and direction for a target tooth. By way of example, d2 of the exemplary water cannon fold 395 shown in FIG. 8 is in a range from about 1 mm to about 2 mm.

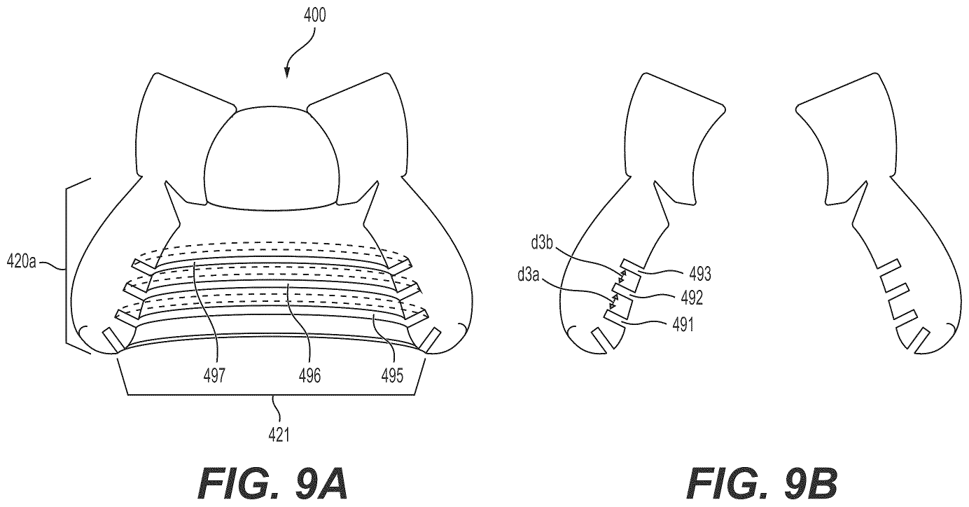

Optionally, more than one water cannon fold is incorporated in the inside surface of the cleaning membrane. The two or more water cannon folds can be arranged in parallel with each other with a suitable distance in between the neighboring water cannon folds. Each water cannon fold runs from a first side edge to an opposite second side edge of the wing and has an opening that points at the gingival sulcus, the periodontal pocket, and/or a gum-implant interface. For example, as shown in FIGS. 9A and 9B, three water cannon folds 495, 496, and 497 are incorporated into the cleaning membrane 421 of wing 420a. The three water cannon folds 495, 496, and 497 are arranged in parallel with each other on the inside surface of the cleaning membrane, with a distance (i.e. d3a, d3b) in between the neighboring water cannon folds. The first distances d3a may be the same as or different from the second distance d3b. Each of the water cannon folds 495, 496, and 497 has an opening 491, 492, and 493, respectively, pointing at the gingival sulcus, the periodontal pocket, and/or a gum-implant interface.

As described above, the curvature on the inside surface of the cleaning membrane allows liquid/air and/or bubbles flushing through the interface micro-gaps via hydrofoil effect towards a target surface of a target tooth, the tomography of gingival sulcus (e.g. sub-gumline niches) and/or periodontal pocket. The incorporation of one or more water cannon fold(s) in the cleaning membrane provides an additional feature targeting the periodontal pocket for efficient removal of biofilms by ejecting liquid/air and/or bubbles directly towards the periodontal pocket.

iii. Mega-and Micro-Nipples

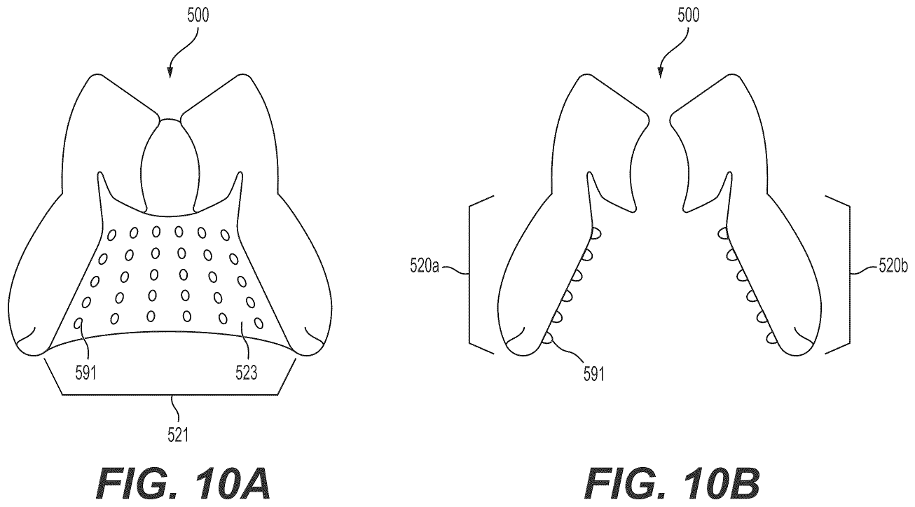

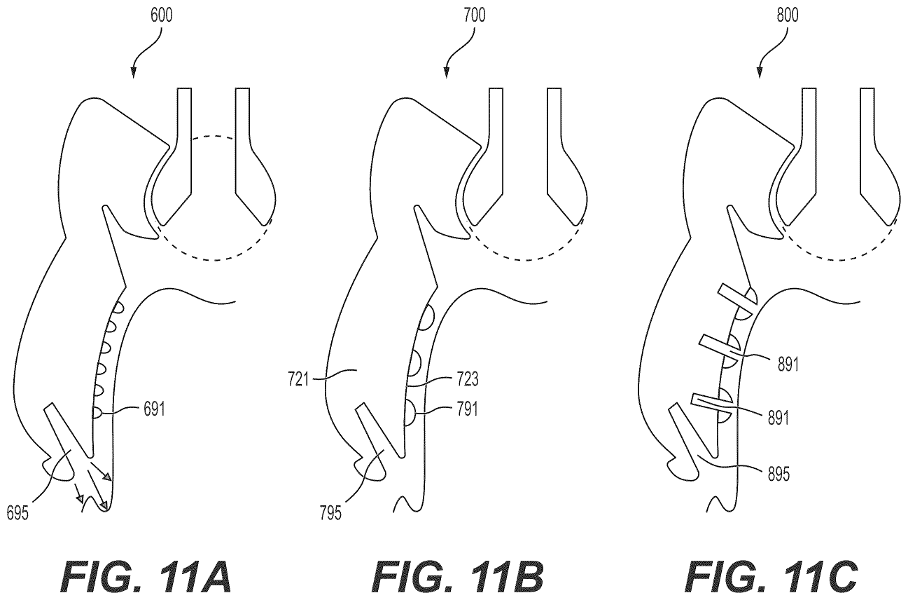

A plurality of mega-and/or micro-nipples 791, 591 may be incorporated on the inside surface(s) of the cleaning membrane(s) of one wing or both wings of the Dome. FIGS. 10A & B as well as FIGS. 11A & B. Optionally, a plurality of mega-nipples 751 are incorporated on the inside surface of the cleaning membrane of one wing of the Dome. Optionally, a plurality of mega-nipples is incorporated on the inside surfaces of the cleaning membranes of both bilateral wings of the Dome. Optionally, a plurality of micro-nipples 591 are incorporated on the inside surface of the cleaning membrane of one wing of the Dome. Optionally, a plurality of micro-nipples is incorporated on the inside surfaces of the cleaning membranes of both bilateral wings of the Dome. Optionally, a first plurality of mega-nipples and a second plurality of micro-nipples are incorporated on the inside surface of the cleaning membrane of one wing of the Dome. Optionally, a first plurality of mega-nipples and a second group of micro-nipples is incorporated on the inside surfaces of the cleaning membranes of both bilateral wings of the Dome.

The mega-or micro-nipple is protrusion from the inside surface of the cleaning membrane. The mega-or micro-nipple can have any suitable shape such as semi-spherical shape, as long as it does not have a sharp point or edge that may damage the surfaces of the teeth. For example, the mega-or micro-nipple has a semi-spherical cone that protrudes from the inside surface of the cleaning membrane (see, e.g. FIGS. 10A and 10B as well as FIGS. 11A & B). Generally, a micro-nipple 591 can have a diameter in a range from about 0.1 mm to about 1 mm, from about 0.1 mm to about 0.8 mm, or from about 0.2 mm to about 0.6 mm, such as about 0.5 mm. A mega-nipple 791 can have a diameter in a range from >1 mm to about 5 mm, from about 1.2 mm to about 5 mm, from about 1.5 mm to about 3 mm, such as about 1.5 mm, from about 0.5 mm to about 1 mm, or from about 1 mm to about 2 mm.

The incorporation of a plurality of mega-and/or micro-nipples on the inside surface of one or both cleaning membranes of the wings can generate radial tsunami wave in directions to reach hidden surfaces and/or corners to and detach oral biofilms by shearing force. The mega-nipple can generate more radial force compared to the micro-nipple due to its larger size. The selection of mega-or micro-nipples, or a combination thereof depends on the conditions being treated, the user, and the beneficial effect being sought in the particular user. For example, for treating the teeth of children, micro-nipples are selected for applying gentle force on the surface(s) of each target tooth.

The number and location of mega-or micro-nipples incorporated on the inside surface(s) of the cleaning membrane(s) can vary and be determined based on the conditions being treated, the user and the beneficial effect being sought. The number and location of mega-or micro-nipples may be configured to generate a desired radial force and to direct the generated radial force to a desired direction or desired directions targeting one or more particular tooth surfaces. For example, the number of mega-nipples incorporated on the inside surface of the cleaning membrane of only one wing, or each wing of the bilateral wings is in a range from 4 to 24, from 6 to 20, from 8 to 16, or from 10 to 14. For example, the number of micro-nipples incorporated on the inside surface of the cleaning membrane of only one wing, or each wing of the bilateral wings is in a range from 10 to 80, from 15 to 60, from 20 to 50, from 20 to 40, or from 20 to 30.

By way of examples, the exemplary Dome 700 shown in FIG. 11B contains three mega-nipples 791 on each vertical panel on the inside surface 723 of cleaning membrane 721, i.e. a total of twelve mega-nipples are incorporated on the inside surface of the cleaning membrane (only three mega-nipples are visible from the side view shown in FIG. 11B). The exemplary Dome 500 shown in FIGS. 10A and 10B contains more than 25 micro-nipples 591, such as 26, 27, or 28 micro-nipples, incorporated on the inside surface 523 of the cleaning membrane 521 of each of the bilateral wings 520a and 520b, such that the total number of micro-nipples in the Dome is more than 50.

The shape and/or dimensions of the mega-or micro-nipples incorporated on the inside surface of the same cleaning membrane may be the same or different. When a first wing of a Dome contains a plurality of mega-and/or micro-nipples on the inside surface of its cleaning membrane, a second wing of the Dome may or may not contain any mega-or micro-nipples. When the second wing of the Dome also contains mega-and/or micro-nipples, the amount, shape, and/or dimensions of which may be the same as or different from the first wing.

iv. Water Canons with Mega-and Micro-Nipple Heads

A plurality of water cannons with mega-and/or micro-nipple heads may be incorporated on the inside surface(s) of the cleaning membrane(s) of one wing or both wings of the Dome. Optionally, a plurality of water cannons with mega-nipple heads is incorporated on the inside surface of the cleaning membrane of one wing of the Dome. Optionally, a plurality of water cannons with mega-nipple heads is incorporated on the inside surfaces of the cleaning membranes of both bilateral wings of the Dome. Optionally, a plurality of water cannons with micro-nipple heads is incorporated on the inside surface of the cleaning membrane of one wing of the Dome. Optionally, a plurality of water cannons with micro-nipple heads is incorporated on the inside surfaces of the cleaning membranes of both bilateral wings of the Dome. Optionally, a first plurality of water cannons 290 with mega-nipple heads 292 (FIG. 7A) and a second plurality of water cannons with micro-nipple heads are incorporated on the inside surface of the cleaning membrane of one wing of the Dome. Optionally, a first plurality of water cannons with mega-nipple heads and a second plurality of water cannons with micro-nipple heads are incorporated on the inside surfaces of the cleaning membranes of both bilateral wings of the Dome.

The water cannon is as described above, i.e., containing a hollow gun barrel 291 embedded in the inside surface of the cleaning membrane, creating an opening thereon. The gun barrel is positioned perpendicular to a corresponding curvature such that it is also perpendicular to the external curvature of a target tooth, such as the external curvature of premolar/molar, the labile surface of premolar/molar, or the lingual surface of incisors/canine. The gun barrel can have any suitable shape and dimensions, such as any of the shapes and dimensions described above, that provide a sufficient volume to trap the flushing liquid/air and/or bubbles. The mega-and/or micro-nipple head 292, 891 is a protrusion from the inside surface of the cleaning membrane that surrounds the opening of the water cannon (see, e.g. FIGS. 6A-6C, 292 and FIG. 11C). Generally, a micro-nipple head can have a diameter in a range from about 0.1 mm to about 1 mm, from about 0.1 mm to about 0.8 mm, or from about 0.2 mm to about 0.6 mm, such as about 0.5 mm. A mega-nipple head can have a diameter in a range from >1 mm to about 5 mm, from about 1.2 mm to about 5 mm, from about 1.5 mm to about 3 mm, or from about 1 mm to about 2 mm, such as about 1.5 mm.

The water cannons with mega-and/or micro-nipple heads on the inside surface of the cleaning membrane can generate water cannon force by trapping and ejecting liquid/air and/or bubbles in a bouncing mode triggered by ultrasonic vibration (see, e.g. FIG. 7C), and radial tsunami force facilitated by the nipple head (see, e.g. FIG. 7D).

The shape and/or dimensions of the water cannons incorporated on the inside surface of the same cleaning membrane may be the same or different. Water cannons having the same or different shape and/or dimensions may have nipple heads of the same or different shape and/or dimensions. When a first wing of a Dome contains a plurality of water cannons with mega-and/or micro-nipple heads on the inside surface of its cleaning membrane, a second wing of the Dome may or may not contain any water cannons coupled with mega-or micro-nipple heads. When the second wing of the Dome also contains water cannons with mega-and/or micro-nipple heads, the amount, shape, and/or dimensions of which may be the same as or different from the first wing.

### 2. Forces

When in use, liquid/air and/or ultrasonic vibration are flushed/applied to the Dome; the ultrasonic vibration coupled with the curvatures on the inside surface of the cleaning membrane of each wing can generate cavitation force by bubble bursting that release energy to create a suction force on the biofilms (see, e.g. FIG. 7B). Additionally, when one or more cleaning elements such as those described above are incorporated on the inside surface of each cleaning membrane, one or more additional forces can be generated, such as water cannon force by trapping and ejecting liquid/air and/or bubbles in a bouncing mode triggered by ultrasonic vibration (see, e.g. FIG. 7C), and/or radial tsunami force facilitated by the nipple head (see, e.g. FIG. 7D).

a. Cavitation Force

As liquid flushes through the interface micro-gaps in between the inside surfaces of the cleaning membranes and the external curvature of the target tooth, a watery gap hydrofoil effect is generated. Upon application of an ultrasonic vibration, the bubbles are burst, for example by vigorous wing flapping, with energy released to create suction force to detach oral biofilms (see, e.g. FIG. 7B).

b. Water Cannon Force

The incorporation of water cannons, water cannon folds, and/or water cannons with mega-and/or micro-nipples heads allow for the generation of water cannon force (see, e.g. FIG. 7C). When the ultrasonic vibration retracts the facet surface of the gun barrel of a water cannon or the channel of a water cannon fold backwards, liquid/air and/or bubbles are trapped inside the gun barrel or channel. When the gun barrel or fold rebounds forwards, it ejects the liquid/air and/or bubbles outward and towards a target surface of the tooth like a liquid/air bullet.

c. Tsunami Force

The incorporation of mega-and/or micro-nipples, and/or water cannons with mega-and/or micro-nipples heads allow for the generation of Tsunami force with water, and ultrasonic vibration (see, e.g. FIG. 7D). As each panel on the inside surface of the cleaning membrane conforms to an external curvature of a target tooth, ultrasonic vibration can transmit the vertical directional force to break oral biofilms from the tooth surface. For example, as shown in FIG. 7D, ultrasonic vibration from semi-spherical mega-nipple head transmits the radial directional force to shear oral biofilms from the tooth surface.

3. Materials forming the Dome

Suitable materials for forming the Dome include, but are not limited to, an elastomeric material such as ethylene vinyl acetate (EVA), thermoplastic elastomer (TPE), or silicone. Such materials allow motion of the socket ball, the wing-connecting membranes, and the bilateral wings and are soft and flexible for wing flapping and for protecting the teeth and/or gingiva if direct contact is made with the teeth and/or gingiva. A flexible Dome may also provide acceptable fitment over the teeth of a large range of users, due to its ability to conform to the teeth and/or gingiva.

### B. Other Components

The Dome described herein may be included in a system containing the Dome 100 and one or more additional components. The one or more additional components are configured to incorporate the Dome into an element for user operation and to link the Dome to a flow path, providing a fluid/air flow path for supplying a liquid and/or air to the Dome.

Generally, the system includes a base unit 1100, a hand unit 1200, a conduit 1500, and the Dome 100 FIG. 13B. The Dome is attached to the hand unit via the conduit, optionally detachably attached to the hand unit via the conduit. The base unit 1100 includes a pump for controlling the pressure, pulse frequency, and/or velocity of the Dome.

### 1. Conduit

The conduit of the system can be any appropriate means, rigid or flexible, for conveying liquid/air from a liquid/air source and to the Dome, such as a hollow object having a suitable shape, a tube, a channel, a pipe, etc. Suitable materials for forming the conduit include metals and natural and synthetic polymers, such as plastic, grade 5 titanium, titanium alloys, nickel-titanium alloys, cobalt chromium alloys, stainless steel alloys, copper alloys, iron and/or ferrous alloys, nichrome, zinc and galvanized materials, tantalum, kanthal, or cupronickel.

The Dome is attached to a hand unit via the conduit. The Dome may be detachable or undetachable from the conduit. For example, the connecting portion of the Dome 100 is integral with the first opposing end of the conduit 1500, such that the Dome and the conduit form a one-piece part. Alternatively, the Dome is detachable from the conduit, such that different Domes with different curvatures of their wings can be selected and attached to the conduit, thereby fixing the dome on the hand unit for operation.

### 2. Hand Unit

The hand unit of the system 1200 can have any suitable shape and size such that a user may hold it, appropriately position the Dome operably attached thereto to be over the teeth of the user and move the Dome along the dental arch. The hand unit is typically made from a non-conductive material, such as plastic or non-conductive polymers.

The hand unit 1200 typically has two opposing ends: a first opposing end 1291 of the hand unit incorporates the second coupling feature that corresponds to the first coupling feature of the conduit 1500; and a second opposing end 1292 of the hand unit optionally incorporates a third coupling feature that corresponds to a charging port 1110 or a stand of the base unit. FIG. 13C Optionally, the hand unit uses rechargeable batteries, disposable batteries, or it is electrically connected to an external power source, and the second opposing end of the hand unit does not incorporate any coupling feature. The third coupling feature can have any suitable shape and dimensions, such as an indentation, as long as it can be electrically coupled to the charging port 1110 of the base unit or mate with a stand of the base unit that can hold the hand unit, optionally at an upright position.

The hand unit contains a channel 1240 through which liquid/air flows to the conduit and Dome from a liquid/air source, an ultrasonication vibrator, a circuit board, a control, and optionally, a battery chamber for holding rechargeable or disposable battery or batteries.

a. Channel

The channel 1240 is in fluid communication with a liquid/air source, for example, is connected to a tube 1131 connecting to a liquid and/or air source. The conduit is coupled to the hand unit via the first and second coupling features such as those described above and is in fluid communication with the channel. Such a configuration allows liquid and/or air to flow from a liquid and/or air source into the channel in the hand unit, the conduit, and then into the Dome.

b. Battery Chamber and Ultrasonication Vibrator The hand unit can contain a battery chamber 1250 for holding one or more rechargeable or disposable batteries or battery pack. In some forms, the hand unit may include a cord for plugging into a power supply. FIG. 13B In such forms, the hand unit may or may not include a battery chamber for holding a rechargeable or disposable battery or batteries. In forms where the hand unit does not include a battery chamber for holding a rechargeable or disposable battery or batteries, the base unit may include a power source that is electrically connected with the hand unit. Alternatively, the base unit includes a power plug or a power cord that has a power plug attached thereto to allow the system to electrically connect to an external power source.

The battery or batteries or the power supply is in electrical communication with the ultrasonication vibrator 1260. The ultrasonication vibrator can provide ultrasonic vibration to the Dome for generation of the different forces described above. In some forms, the ultrasonication vibrator contains a portion that forms the second coupling feature of the hand unit that correspond to the first coupling feature (see, e.g. FIGS. 13A and 13B). Ultrasonication vibrators that are suitable for use in the system are commercially available.

c. Circuit Board and Control

The hand unit can contain a circuit board 1270 that is electrically connected to a control switch 1280, optionally more than one control, for activating/deactivating the power (i.e., to allow the power to be turned on and off), adjusting the power output, adjusting the duration of cleaning, and/or adjusting the frequency and/or duration of the ultrasonic vibration such as by using a pump that is included in the base unit.

The control may have single function, such as controlling the activation/deactivation of the power, adjusting the power output, or adjusting the duration of cleaning, adjusting the frequency of the ultrasonic vibration, or adjusting the duration of the ultrasonic vibration. Alternatively, the control may have dual-function or multi-function, such as controlling the activation or deactivation of the power and adjusting the power output, adjusting the power output and the duration of cleaning, or adjusting the frequency and duration of the ultrasonic vibration.

Optionally, the hand unit contains two or more controls, each being electrically connected to the circuit board and having one or two functions, such that the user can activating/deactivating the power (i.e., to allow the power to be turned on and off), adjusting the power output, adjusting the duration of cleaning, and adjusting the frequency and/or duration of the ultrasonic vibration.

The circuit board and control(s) allow manual setting of the desired parameters based on the needs of the user. For example, the circuit board and control(s) allow the user to apply a desired power output and/or vibration frequency for a desired duration.

d. Optional Features

The hand unit may have gripping structures (e.g., knurls, ridges, rubber, etc.) 1225 (FIG. 13A) to stabilize it in the hand of the user. For example, the hand unit contains a longitudinal ridge to register the rotational orientation of the hand unit within the hand of the user.

The hand unit may contain an output display that is electrically connected to the circuit board, such that specific parameters (e.g. battery lifetime, power output, duration of cleaning, frequency of ultrasonic vibration, duration of ultrasonic vibration, etc.) are presented on the display. Optionally, an audible signal can be provided when the system is used for a pre-set time period, indicating the end of a cleaning session.

The components contained in the hand unit may be arranged in any suitable relative positions. Two specific examples of the hand unit are described in the Examples (FIGS. 13B and 13C, 1200 and 1200′). Although not shown in FIGS. 13B and 13C, the hand unit 1200 and 1200′ may be modified to include an output display and/or a gripping feature, and/or to remove the battery chamber and include a cord instead for plugging into a power supply.

### 3. Base Unit

The base unit of the system contains a tank, one or more tubes, a motor 1140 driving a pump, and optionally, a charging port 1160, a pressure regulator, a switch 1176, an air channel, a tubing storage element 1170, a stand 1150 for holding an additional hand piece. FIG. 13A

a. Tank

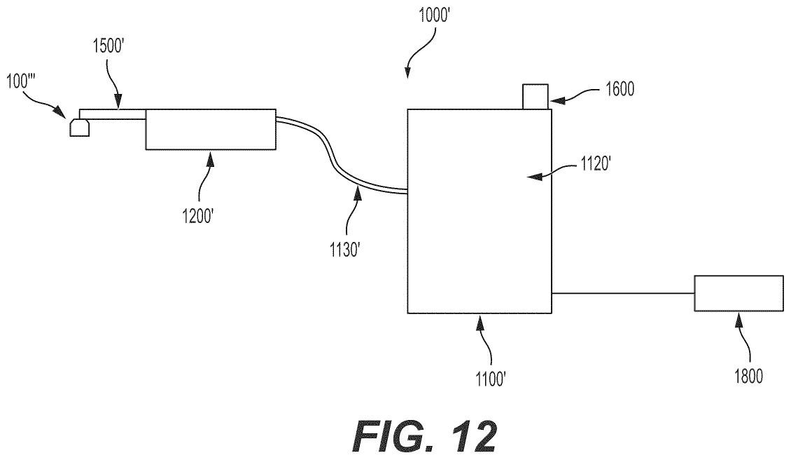

The tank 1120 has a body 1121 defined by a wall or more than one wall, and a lid 1122. The lid may be integral with the body or detachable from the body 1121. Optionally, the tank includes a drug inlet port 1600 configured for adding a drug tablet or a drug solution into the tank. The drug inlet port is in fluid communication with the body and can be located at any suitable location on the tank, such as on the lid of the tank (see, e.g., FIG. 12). The body of the tank can have any shape and dimensions as long as it has a volume sufficient to hold a liquid for flushing the teeth, such as water or an aqueous solution formulated for treating a condition of the teeth. The tank 1120 may be detachable from the base unit 1100, such that an empty tank may be replaced with a tank filled with liquid or refilled with liquid for reuse. Optionally, the system includes a water feeding element 1160 (e.g. a tube, a pipe, etc.), via which the tank is connected to a water source, such as a faucet. The water feeding element is in fluid communication with the body of the tank, such that water can be refilled manually or automatically though the water feeding element.

b. Tubes

The hand unit 1200 is connected to the liquid in the tank and/or air via the one or more tubes 1130, such that the tube(s) of the base unit is in fluid communication with the channel 1240 contained in the hand unit.

For example, as shown in FIG. 13A, a tube 1131 connects the hand unit to a first inlet 1132a of a three-way adapter 1132. The adapter 1132 has a second inlet 1132b connecting to a tube 1133 that is in fluid communication with air, and a third inlet 1132c connecting to a tube 1134 that is connected to the body 1121 of the tank 1120.

Accordingly, air from the external environment can flow through an air channel 1810, tube 1133, adapter 1132, and tube 1131 into the hand unit 1200; liquid from the tank can flow through tube 1134, adapter 1132, and tube 1131 into the hand unit 1200. The adapter 1132 may contain one or more valves such that a user can adjust the flow to allow air or liquid, or both air and liquid to flow into the hand unit 1200.

c. Motor and Pump

The base unit includes a motor 1140, optionally more than one motor, that drives the flow of liquid and/or air from the tank 1120 and external environment through the tubes and into the hand unit.

The base unit includes a pump as a part of motor 1140, optionally more than one pump, that controls the pressure, pulse frequency, and/or velocity of the liquid flow, as well as the generation of vibration at the Dome. Optionally, the base unit 1100 further includes a pressure regulator at the output of motor/pump 1140, which allows for adjusting any of the above-described parameters.

Optionally, the base unit further includes a switch 1176 that is electrically connected to the pump by which the pump and/motor is turned on and off by connecting and disconnecting it from. a power port or a power cord 1178.

d. Charging Port or Stand

The base unit 1100 can include a charging port. As described above, the charging port or stand 1110 has a shape and dimensions that correspond to the third coupling feature 1240 on one opposing end of the hand unit 1200, such that the third coupling feature is electrically coupled to the charging port of the base unit or mate with the stand of the base unit for holding the hand unit, optionally at an upright position.

e. Other Components

The system may include one or more additional stands for holding one or more additional conduits provided in the same system. For example, as shown in FIG. 13A, the exemplary system 1000 includes a stand 1150 for holding an additional conduit 1500′.

The system may include a tubing storage element 1170 (see, e.g. FIG. 13A). The tubing storage element included in the system allows incorporation of a long tube connecting the hand unit and the base unit, such that the user can operate the hand unit at a variety of distances from the base unit.

### II. Methods of Using

Methods of using systems incorporating the Dome described herein for oral cleaning in a subject in need thereof are disclosed.

Generally, the methods include (i) moving the Dome 100 along the dental arch of the subject. As the Dome is moved along the dental arch, liquid and/or air are ejected through the outlet 134 of the socket ball 130 of the Dome at a pressure in a range from about 0.5 psi to about 30 psi, from about 1 psi to about 20 psi, or from about 3 psi to about 15 psi, at a pulse frequency in a range from 0.5 Hz to about 50 Hz, from about 1 Hz to about 40 Hz, or from about 5 Hz to about 25 Hz, and/or at a delivery pulse volume in a range from about 0.1 mL to about 150 mL, from about 0.2 mL to about 120 mL, from about 0.5 mL to about 100 mL, or from about 1 mL to about 50 mL. The delivery pulse volume is the total volume of water or air ejected from the outlet of the socket ball at each pulse. When an ultrasonic vibration is provided to the Dome, the ultrasonic vibration can have a frequency in a range from about 100 to about 5000 vibrations per second, from about 500 to about 4000 vibrations per second, or from about 1000 to about 3000 vibrations per second.

The liquid used in the methods described herein can be water or an aqueous solution containing one or more active agents in an amount effective to provide the effect sought. Active agents suitable for forming the aqueous solution include, but are not limited to, cleaning agents, antimicrobial agents, mineralization agents, desensitizing agents, and whitening agents, and a combination thereof. The specific concentration of the active agent or each active agent in the aqueous solution depends on the specific agent being used, the conditions being treated, the specific subject, and the beneficial effect being sought.

Optionally, the methods also include attaching the Dome onto the hand unit prior to step (i); placing the Dome over a tooth of the subject prior to step (i); activating the power of the hand unit prior to or subsequent to step (i); selecting or adjusting the power output, duration of cleaning, frequency of ultrasonic vibration, and/or duration of ultrasonic vibration prior to or during step (i); maintaining the Dome over a target tooth for a period of time; switching between liquid and air during step (i); and/or rinsing mouth with a mouthwash prior to and/or subsequent to step (i).

The disclosed devices, systems, and methods of using can be further understood through the following enumerated paragraphs.
1. A Dome for removing dental plaque/oral biofilms from a target surface or all surfaces of a tooth, comprising:
   a socket head,
   a socket ball, and
   a pair of opposing bilateral wings,
   wherein the socket head comprises two wing-connecting membranes and a top,
      wherein the top comprises at least one set of opposite sides and an opening located at or near the center of the top,
      wherein the two wing-connecting membranes are bonded to the set of opposite sides of the top,
      wherein the wing-connecting membranes and top form a joint housing,
   wherein the socket ball comprises a head portion and a connecting portion,
      wherein the head portion is positioned inside the joint housing,
      wherein the connecting portion passes through the opening of the top,
   wherein each of the bilateral wings is bonded to the proximal end of one of the wing-connecting membranes via a connecting edge.
2. The Dome of paragraph 1, wherein each of the wing-connecting membranes comprises an inside surface and an outside surface, wherein a gap is positioned between a majority of the surface of the socket ball and the inside surface of each of the wing-connecting membranes.
3. The Dome of paragraph 1 or 2, wherein each of the bilateral wings extends downwardly from the wing-connecting membrane to which it is bonded.
4. The Dome of any one of paragraphs 1-3, wherein an open region is located in a joining area that joins each of the bilateral wings and the wing-connecting membrane to which it is bonded.
5. The Dome of any one of paragraphs 1-4, wherein each of the bilateral wings comprises a cleaning membrane, a base portion, and two side portions, wherein the base portion is connected to the cleaning membrane via a bottom edge and the side portions are connected to the cleaning membrane via a pair of opposite side edges.
6. The Dome of paragraph 5, wherein the cleaning membrane of each of the bilateral wings comprises an inside surface and an outside surface, wherein the outside surfaces of the cleaning membranes of the bilateral wings have a curvature such that the bilateral wings enclose each target tooth when in use.
7. The Dome of paragraph 6, wherein the inside surface of the cleaning membrane comprises a vertical plane, optionally two or more vertical planes aligned side-by-side, wherein the vertical plane, optionally each vertical plane of the two or more vertical planes, comprises a curvature that conforms to the external curvature of one or more types of teeth.
8. The Dome of any one of paragraphs 5-7, wherein each of the base portion and two side portions has a curved shape such that is rolled away from the periodontal tissues when in use.
9. The Dome of any one of paragraphs 5-8, wherein one or both of the bilateral wings comprise(s) a cleaning element, optionally two or more cleaning elements, incorporated on the inside surface of the cleaning membrane and/or at a base of the cleaning membrane.
10. The Dome of paragraph 9, wherein the cleaning element, optionally each cleaning element of the two or more cleaning elements, is a plurality of water cannons, water cannon folds or two or more water cannon folds, a plurality of mega-nipples, a plurality of micro-nipples, or a plurality of water cannons coupled with mega-/micro-nipple heads.
11. The Dome of paragraph 10, wherein each water cannon of the plurality of water cannons comprises a hollow gun barrel, wherein the hollow gun barrel is embedded in the inside surface of the cleaning membrane, creating an opening thereon.
12. The Dome of paragraph 11, wherein each water cannon of the plurality of water cannons is positioned such that it is perpendicular to the external curvature of a target tooth.
13. The Dome of paragraphs 11 or 12, wherein the hollow gun barrel has a tapered cylindrical shape.
14. The Dome of any one of paragraphs 10-13, wherein the water cannon fold or each water cannon fold of the two or more water cannon folds comprises a continuous channel along the bottom edge of the cleaning membrane.
15. The Dome of paragraph 14, wherein the channel comprises an opening positioned at an angle pointing at the periodontal pocket, wherein the channel has a depth sufficient to trap liquid/air and/or bubbles when in use.
16. The Dome of any one of paragraphs 10-15, wherein the two or more water cannon folds are arranged in parallel with each other with a suitable distance in between neighboring water cannon folds.
17. The Dome of any one of paragraphs 10-16, wherein each mega-nipple of the plurality of mega-nipples and/or each micro-nipple of the plurality of micro-nipples comprises a semi-spherical cone that protrudes from the inside surface of the cleaning membrane.
18. The Dome of any one of paragraphs 10-17, wherein each mega-nipple of the plurality of mega-nipples has a diameter in a range from >1 mm to about 5 mm, from about 1.2 mm to about 5 mm, from about 1.5 mm to about 3 mm, such as about 1.5 mm, from about 0.5 mm to about 1 mm, or from about 1 mm to about 2 mm; each micro-nipple of the plurality of micro-nipples has a diameter in a range from about 0.1 mm to about 1 mm, from about 0.1 mm to about 0.8 mm, or from about 0.2 mm to about 0.6 mm, such as about 0.5 mm.
19. A system for removing dental plaque/oral biofilms from a target surface or all surfaces of a tooth, comprising:
   the Dome of any one of paragraphs 1-18,
   a conduit, and
   a hand unit,
   wherein the hand unit comprises a channel and two opposing ends,
   wherein the dome is attached to one of the opposing ends of the hand unit via the conduit, and
   wherein the channel of the hand unit is in fluid communication with a liquid and/or air source and is in fluid communication with the conduit and the dome.
20. The system of paragraph 19, wherein the dome is integral with or detachably attached to the conduit, and/or wherein the conduit is integral with or detachably attached to the hand unit.
21. The system of paragraphs 19 or 20, wherein the hand unit further comprises a chamber for a rechargeable battery or disposable battery, gripping structures, an output display, or an audio component, or a combination thereof.
22. The system of any one of paragraphs 19-21, wherein the hand unit further comprises an ultrasonication vibrator, a circuit board, or a control, or a combination thereof.
23. The system of any one of paragraphs 19-22, further comprising a base unit, wherein the base unit comprises a tank and a tube, wherein the other opposing end of the hand unit is connected to the tank via the tube such that the channel of the hand unit is in fluid communication with a liquid inside the tank.
24. The system of paragraph 23, wherein the base unit further comprises an air channel configured to be in fluid communication with the channel of the hand unit via the tube.
25. The system of paragraph 23 or 24, wherein the base unit further comprises a motor and a pump, and optionally a pressure regulator, a power switch, a charging port, a tubing storage element, a stand for holding an additional conduit, and/or a water feeding element.
26. The system of paragraph 25, wherein the base unit further comprises a power port or a power cord configured to connect the system to an external power source.
27. The system of any one of paragraphs 20-26, wherein the tank comprises a body defined by a wall or two or more walls, and a lid, wherein the lid is integral with or detachably attaches to the body.
28. The system of paragraph 27, wherein the tank further comprises a drug inlet port configured to allow the addition of a drug table or a drug solution into the tank, optionally, wherein the drug inlet port is located on the lid of the tank.
29. A method for oral cleaning in a subject in need thereof using the system of any one of paragraphs 20-28, comprising:
   (i) moving the Dome along the dental arch of the subject.
30. The method of paragraph 29, wherein during step (i), liquid and/or air are ejected through an outlet of the socket ball of the Dome at a pressure in a range from about 0.5 psi to about 30 psi, at a pulse frequency in a range from about 0.5 Hz to about 50 Hz, and/or at a delivery pulse volume in a range from about 0.1 mL to about 150 mL.
31. The method of paragraphs 29 or 30, further comprising providing an ultrasonic vibration to the Dome prior to and/or during step (i), wherein the ultrasonic vibration has a frequency in a range from about 100 to about 5000 vibrations per second, from about 500 to about 4000 vibrations per second, or from about 1000 to about 3000 vibrations per second.
32. The method of any one of paragraphs 29-31, further comprising attaching the Dome onto the conduit and/or hand unit prior to step (i); placing the Dome over a tooth of the subject prior to step (i); activating the power of the hand unit prior to or subsequent to step (i); selecting or adjusting the power output, duration of cleaning, frequency of ultrasonic vibration, and/or duration of ultrasonic vibration prior to or during step (i); maintaining the Dome over a target tooth for a period of time; switching between liquid and air during step (i); and/or rinsing the user's mouth with a mouthwash prior to and/or subsequent to step (i).

The present invention will be further understood by reference to the following non-limiting examples.

### Examples

### A. Exemplary Domes

FIGS. 1A-1F, 2A-2B, 3A-3D, 4, and 5A-5D illustrate different views of exemplary domes 100 and 100″ that can be attached to a hand unit via a conduit 1500. As shown in FIG. 2A, the dome 100 includes a socket head 110, a socket ball 130, and two bilateral wings 120a and 120b. The socket head includes two wing-connecting membranes 114a and 114b, and a top 116, together forming a joint housing 111. The joint housing 111 has a size and a shape such that it mates with the socket ball 130. The two wing-connecting membranes 114a and 114b are on a second set of opposite sides of the top. The top 116 contains an opening 117 located at or near the center of the top. The opening is a shaped hole, such as a circular hole, which is configured to mate with a connecting portion 131 of the socket ball 130. The opening may have a dimension such that the top is in contact with the connecting portion of the socket ball (see, e.g., FIG. 1A), or there is a gap 163 between the top of the socket head and the socket ball (see, e.g., FIG. 1C). A head portion 133 of the socket ball 130 is detachably mounted inside the joint housing 111 with the connecting portion 131 passing through the opening 117 on the top 116 for connecting with the conduit 1500, forming a ball-and-socket joint 160 (also referred to herein as a “spheroidal joint”). The connecting portion can have any suitable shape and dimensions, as long as it corresponds with the shape and dimension of the opening on the top of the socket head such that it is able to pass through the opening 117 and connect to the conduit. A gap 161a or 161b is positioned between a majority of the surface area of the socket ball 130 and the inside surfaces of each of the wing-connecting membranes 114a and 114b to allow movement of the socket ball and/or the wing-connecting membranes, such that the socket ball 130 can rotate and move inside the joint housing 111, thereby allowing proper delivery of liquid/air to a target surface or all surfaces of a target tooth for cleaning. For example, the head portion 133 of the socket ball 130 can be positioned to tilt towards the inner surface of one of the bilateral wings 120a and 120b, at an angle relative to the center axis of the Dome 100. The angle may be approximately 0 to 60 degrees, or approximately 30 degrees depending on the position of a target surface of a target tooth.

The socket ball 130 contains a liquid/air channel 132 running through a center axis of the socket ball with an outlet 134, which is in fluid communication with the conduit 1500, such that water and/or air is provided to the liquid/air channel 132 through the conduit 1500, and then flushed to a target surface or all surfaces of a target tooth (e.g. labial/buccal, lingual, inter-dental space, gingival sulcus, and/or periodontal pocket) through the outlet 134.

The proximal end 113a or 113b of each of the wing-connecting membranes 114a and 114b is bonded to a wing 120a or 120b extending downwardly from each membrane by a suitable technique, such as thermal bonding. Alternatively, the wing-connecting membrane 114a (or 114b) and the wing 120a (or 120b) is a unitary piece (i.e. a one-piece structure). A triangular open region 140a or 140b is located in a joining area 115a or 115b that joins the wing 120a or 120b and the wing-connecting membrane 114a or 114b. The open region 140a or 140b is configured to allow movement of the wing, such that the angle between an imaginary vertical measuring line 171 (which aligns with the central vertical axis of the socket ball) and each of the wings 120a and 120b can vary during ultrasonic vibration and/or to accommodate teeth of different sizes. Although not shown, the open region can have any suitable shape and dimensions, such as a rectangle, a square, a trapezoid, a cut line, etc., as long as it is positioned in the joining area and allows for movement of the wing. As shown in FIG. 2A and 2B, each of the bilateral wings 120a and 120b forms a first angle α1 with the imaginary vertical measuring line 171 to accommodate one or more of incisors and canines (FIG. 2A) or forms a second angle α2 with the imaginary vertical measuring line 171 to accommodate one or more of the premolars and molars (FIG. 2B). The second angle α2 is larger than the first angle α1 due to the larger width of premolars and molars compared to incisors and canines.

As shown in FIG. 3A, each of the bilateral wings contains a cleaning membrane 121 having an inside surface 123 and an outside surface 125 (not visible in FIG. 3A; see, e.g. FIG. 5B), a base portion 127 (not visible in FIG. 3A; see, e.g. FIG. 5B), and two side portions 129a and 129b (not visible in FIG. 3A; see, e.g. FIG. 5B). As shown in FIG. 5B, the base portion 127 is connected to the cleaning membrane 121 via a bottom edge 175; the side portions 129a and 129b are connected to the cleaning membrane 121 via a pair of opposite side edges 177a and 177b, respectively; and the cleaning membrane 121 is connected to the wing-connecting membrane of the socket head via a connecting edge 173. The connecting edge 173, bottom edge 175, and two side edges 177a and 177b define a length (L) and a width (W) of each wing. The length, L, is measured from the connecting edge 173 to the bottom edge 175. The width, W, is measured from a first side edge 177a to a second side edge 177b. The length (L) and width (W) of each wing are sufficient to cover the labial/buccal and lingual surfaces of a tooth, such as a length (L) in a range from about 10 mm to about 20 mm, optionally from about 10 mm to about 18 mm or from about 10 mm to about 16 mm, for example about 11 mm, and a width (W) in a range from about 5 mm to about 25 mm, optionally from about 5 mm to about 20 mm, from about 10 mm to about 20 mm, or from about 5 mm to about 8 mm, for example about 6 mm or 18 mm. The distance between the bottom edges of the wings may be from about 5 mm to about 25 mm, from about 5 mm to about 20 mm, from about 5 mm to 15 mm, or from about 5 mm to 10 mm. The distance in between the inside surface 123 and outside surface 125 defines a thickness (T) of each wing. The thickness, T, of each wing is sufficient to incorporate one or more cleaning elements on the inside surface, as described in detail below.

The outside surface 125 of each wing has a curvature such that the two wings enclose each target tooth. Typically, the outside surface 125 is smooth to minimize irritation to the mouth cavity during operation. Alternatively, the outside surface 125 may be configured to mirror the inside surface 123 of each cleaning membrane 121, such that a user can pick the right Dome for use. The inside surface 123 of each cleaning membrane 121 contains one or more vertical planes, such as two vertical panels 122, 124, aligned side-by-side. Each panel contains a curvature that conforms to the external curvature of one type of teeth (e.g. premolar/molar or incisor/canine). Each of panels 122 and 124 contains a curvature 182 that conforms to the external curvature of premolar/molar; a curvature 184 that conforms to the buccal curvature of incisor/canine; or a curvature 186 that conforms to the lingual curvature of incisor/canine. The dotted lines shown in FIGS. 3B-3D illustrate the different curvatures on the inside surface of the cleaning membrane from the side that conform to the external curvature of premolar/molar (FIG. 3B), the buccal curvature of incisor/canine (FIG. 3C), and the lingual curvature of incisor/canine (FIG. 3D), respectively.

The different curvatures 182, 184, and 186, on the inside surface of the cleaning membrane allow the bilateral wings to conform to the different curvatures for all types of human teeth. When the Dome is moved along the dental arch, there is at least one panel on each wing containing a curvature that conforms to the buccal and lingual curvatures of each tooth. As shown in FIG. 4, when in use, water and bubbles are flushed out from the outlet 134 of the socket ball 130, creating two interface micro-gaps: a first interface micro-gap 191 between the labial/buccal surface 301 of a tooth being treated (also referred to herein as “target tooth”) and its corresponding curvature on the inside surface of the cleaning membrane, and a second interface micro-gap 192 between the lingual surface 302 of the tooth and its corresponding curvature on the inside surface of the cleaning membrane. The “corresponding curvature” refers to the curvature on the inside surface of the cleaning membrane that conforms to an external surface (labial/buccal or lingual) of the target tooth. The interface micro-gaps 191 and 192 in between the external surfaces of the target tooth and their corresponding curvatures of the wing can guide the liquid/air and/or bubbles to flush through these micro-gaps via hydrofoil effect, and towards the tomography of gingival sulcus (e.g. sub-gumline niches) and/or periodontal pocket, to detach and flush out the oral biofilms. Optionally, when an ultrasonic vibration is applied, these micro-gaps also allow the ultrasonic vibration wave being emitted in a vertical direction towards the surfaces of the target tooth to detach the oral biofilms. Each tooth is treated in turn as the Dome moves from the back molar on the left to the back molar on the right along the dental arch.

As shown in FIGS. 1A-1B and 5A-5D, each of the base portion 127 and two side portions 129a and 129b of the wing have a curved shape such that it rolls away from the periodontal tissues to minimize any traumatic effect to the periodontal tissues as the Dome moves along the dental arch. As shown in FIG. 5B, instead of pointing to and creating a sharp contact edge with the periodontal tissue when in use (the dotted lines), the base portion 127 of the wing has an OMEGA shape (the solid lines) that rolls outwardly from the periodontal tissues and provides a smooth contact edge with the periodontal tissue. FIG. 5B illustrates a perspective view of the base portion 127, showing the OMEGA shape along the entire width of the wing, running from the first side edge 177a to the opposite second side edge 177b. FIG. 5C illustrates an enlarged side view of the base portion, showing the OMEGA-shaped base portion 127 that rolls outwardly and upwardly from the bottom edge 175 connecting the cleaning membrane 121 (the cleaning membrane is not shown in FIG. 5C). As shown in FIGS. 1A and 1B, each of the two side portions 139a and 139b on each wing rolls outwardly and inwardly from the side edge 177a or 177b via which it connects to the cleaning membrane 121. The distal end (i.e. 139a or 139b) of each side portion is located at a distance D1 (measured from an imaginary horizontal measuring line Lm1 through the center of the opening 117) that is larger than a distance D2 (measured from the horizontal imaginary measuring line Lml to the inside surface of the cleaning membrane 121), such that the side edges of each wing do not contact the periodontal tissue with any sharp point. FIG. 5D illustrates an enlarged bottom view of the side portion 129a (or 129b), showing the OMEGA-shaped side portion 129a (or 129b) that rolls outwardly and inwardly from a side edge.

FIGS. 6A-6C show different curvatures (i.e. 282, 284, and 286) on the inside surface 223 of an exemplary dome 200, each having a plurality of water cannons coupled with nipple heads, collectively referred to as 290, incorporated thereon. As shown in FIG. 7A, each of the plurality of water cannons coupled with nipple heads 290 contains a hollow gun barrel 291 embedded in the inside surface of the cleaning membrane, creating an opening 293 thereon, and a nipple head 292 surrounding the opening 293 of the gun barrel. The nipple head 292 can be a micro-nipple head (having a diameter in a range from 0.1 mm to 2 mm, or from about 1 mm to about 2 mm) or a macro-nipple head (having a diameter in a range from 1 mm to 5 mm, or from about 2 mm to about 3 mm) that protrudes slightly above the inside surface of the cleaning membrane. The hollow gun barrel 291 is positioned perpendicular to a corresponding curvature such that it is also perpendicular to the external curvature of a target tooth, such as the external curvature of a premolar/molar (FIG. 6A), the labile surface of a premolar/molar (FIG. 6B), or the lingual surface of an incisor/canine (FIG. 6C). The hollow gun barrel 291 has a depth (d1) (measured from the opening 293 to the bottom 294 of the gun barrel) that is sufficient to trap liquid/air and/or bubbles in and subsequently eject the trapped liquid/air and/or bubbles towards the external surfaces of a target tooth when in use. The depth (d1) of the gun barrel can be adjusted to achieve a desired force, ejecting distance, and direction for a target tooth.

When in use, liquid/air and/or ultrasonic vibration are flushed/applied to the Dome; the water cannons coupled with nipple heads 290 on the inside surface of each wing can generate (1) cavitation force by bubble bursting that releases energy to create a suction force on the biofilms (FIG. 7B), (2) water cannon force by trapping and ejecting liquid/air and/or bubbles in a bouncing mode triggered by ultrasonic vibration (FIG. 7C), and/or (3) radial tsunami force facilitated by the nipple head (FIG. 7D).

FIG. 8 shows a perspective view of one side of an exemplary dome 300 having a water cannon fold 395 incorporated on the inside surface 323 of the cleaning membrane 321 of wing 320a. The water canon fold 395 is a continuous channel positioned above and along the bottom edge 375 of wing 320a. The channel can have any suitable shape, such as a trapezoidal shape, a conical shape, a half-cylindrical shape, a half-spherical shape, etc. The water canon fold 395 runs from a first side edge 377a to an opposite second side edge 377b of wing 320a. The water canon fold 395 has an opening 399 positioned at an angle pointing at the periodontal pocket, and a depth (d2) measured from the opening 399 to the bottom 391 of the channel. The depth (d2) of the water cannon fold is sufficient to trap liquid/air and/or bubbles, such that with an applied ultrasonic vibration, the water cannon fold 395 can trap liquid/air and/or bubbles and subsequently eject the trapped liquid/air and/or bubbles towards the gingival sulcus and/or the periodontal pocket of the user. The depth (d2) of the water cannon fold can be adjusted to achieve a desired force, ejecting distance, and direction for a target tooth. By way of example, d2 of the exemplary water cannon fold 395 is in a range from about 2 mm to about 3 mm. The dome 300 has two features targeting the periodontal pocket for efficient removal of biofilms: (1) liquid/air and/or bubbles flushing through the interface micro-gaps 191, 192 via hydrofoil effect towards the tomography of gingival sulcus (e.g. sub-gumline niches) and/or periodontal pocket, and (2) liquid/air and/or bubbles ejected from the water cannon fold towards the periodontal pocket.

FIG. 9A shows a perspective view of one side of an exemplary dome 400 having three water cannon folds 495, 496, and 497 incorporated on the cleaning membrane 421 of wing 420a. FIG. 9B shows a side view of bilateral wings 420a and 420b, each incorporating three water cannon folds, 495, 496, and 497. The three water cannon folds 495, 496, and 497 are arranged in parallel with each other on the inside surface of the cleaning membrane, with a distance (i.e. d3a, d3b) in between the neighboring water cannon folds. The first distances d3a may be the same as or different from the second distance d3b. Each of the water cannon folds 495, 496, and 497 has an opening that points at the gingival sulcus, the periodontal pocket, and/or a gum-implant interface of the user.

FIG. 10A illustrates a perspective view of one side of an exemplary dome 500 having a plurality of micro-nipples, collectively referred to as 591, incorporated on the inside surface 523 of the cleaning membrane 521. FIG. 10B illustrates a side view of two bilateral wings 520a and 520b, each incorporating a plurality of micro-nipples 591 on the inside surface of the cleaning membrane. Each of the plurality of micro-nipples 591 is a semi-spherical cone protruding from the inside surface 523 of the cleaning membrane. When in use, these micro-nipples 591 can generate radical tsunami waves in all directions toward the external surfaces of a target tooth to detach the oral biofilms by shearing force (see, e.g. FIG. 7E).

FIGS. 11A-11C illustrate cross-sectional views of exemplary Domes 600, 700, and 800, showing one wing of each Dome having different cleaning elements incorporated on the inside surface of the cleaning membrane. As shown in FIG. 11A, Dome 600 contains a plurality of micro-nipples 691 and a water cannon fold 695 incorporated on the inside surface of the cleaning membrane. As shown in FIG. 11B, Dome 700 contains a plurality of mega-nipples 791 and a water cannon fold 795 incorporated on the inside surface of the cleaning membrane. As shown in FIG. 11C, Dome 800 contains a plurality of water cannon coupled with nipple heads 891 and a water cannon fold 895 incorporated on the inside surface of the cleaning membrane. Although not shown in FIGS. 11A-11C, the other wing of Domes 600, 700, or 800 can have the same or different cleaning elements or none of the cleaning elements incorporated on the inside surface of its cleaning membrane. If the other wing of each Dome has the same cleaning elements incorporated on the inside surface of its cleaning membrane, the cleaning elements may have an amount or be arranged the same as or different from those on the wing shown in FIGS. 11A-11C.

### B. Exemplary Systems

Exemplary systems incorporating the Dome for oral cleaning are illustrated in FIGS. 12 and 13A-13C.

As shown in FIG. 13A, an exemplary system 1000 includes a base unit 1100, a hand unit 1200, a conduit 1500, and a Dome 100′. The Dome 100′ is attached to the hand unit 1200 via the conduit 1500. The Dome 100′ can have any one of the structures as described above for exemplary Domes 100-800. The conduit 1500 has two opposing ends 1510 and 1520. The Dome 100′ is attached to a first opposing end 1510 of the conduit 1500 by any suitable coupling mechanism, such as heat sealing, stabling, fitting, screwing, or any other suitable mechanical coupling. Alternatively, the connecting portion 131′ of the Dome 100′ is integral with or attaches to the first opposing end 1510 of the conduit 1500, such that the Dome and the conduit is a one-piece part or two separate parts. A second opposing end 1520 of the conduit 1500 contains a first coupling feature 1530, such as a female or male plug feature, which can be coupled to a second coupling feature 1230 of the hand unit 1200 that corresponds to the first coupling feature 1530, such as a male or female plug feature. The hand unit 1200 has two opposing ends 1210 and 1220. A first opposing end 1210 of the hand unit incorporates the second coupling feature 1230 that corresponds to the first coupling feature 1530 of the conduit; a second opposing end 1220 of the hand unit incorporates a third coupling feature 1240 that corresponds to a charging port 1110 of the base unit. The third coupling feature 1240 can have any suitable shape and dimensions, such as an indentation, as long as it can be electrically coupled to the charging port 1110 of the base unit.

The base unit 1100 contains a tank 1120, one or more tubes (collectively referred to as 1130), a tubing storage element 1170, a motor 1140, a stand 1150 for holding an additional conduit 1500′, and a water feeding element 1160. The tank 1120 has a body 1121 and a lid 1122. The body 1121 of the tank has a volume sufficient to hold a liquid for flushing the teeth, such as water or an aqueous solution formulated for treating a condition of the teeth. The tank 1120 may be detachable from the base unit, such that an empty tank may be replaced with a tank filled with liquid or refilled with liquid for reuse. Alternatively, the tank 1120 is connected to a water/drug source, via the water/drug feeding port 1160; the feeding port 1160 is in fluid communication with the body 1121 of the tank, such that water/drug can be refilled manually or automatically though the feeding port. The hand unit 1200 is connected to the liquid in the tank and air via the one or more tubes 1130. As shown in FIG. 13A, a tube 1131 connects the hand unit to a first inlet 1132a of a three-way adapter 1132. The adapter 1132 has a second inlet 1132b connecting to a tube 1133 that is in fluid communication with air, and a third inlet 1132c connecting to a tube 1134 that is connected to the body 1121 of the tank 1120. Accordingly, air from the external environment can flow through tube 1133, adapter 1132, and tube 1131 into the hand unit 1200; liquid from the tank can flow through tube 1134, adapter 1132, and tube 1131 into the hand unit 1200. The adapter 1132 may contain one or more valves such that a user can adjust the flow to allow air or liquid, or both air and liquid to flow into the hand unit 1200. The tubing storage element 1170 allows incorporation of a long tube connecting the hand unit and the base unit, such that the hand unit can be used at a variety of distances from the base unit. The motor/pump 1140 drives the flow of liquid and/or air from the tank and external environment through the tubes and into the hand unit.

As shown in FIG. 13B, the hand unit 1200 contains a channel 1240 for liquid/air to flow through, a battery chamber 1250 for holding a rechargeable battery or disposable batteries, an ultrasonication vibrator 1260, a circuit board 1270, and a control 1280. The channel 1240 is connected to tube 1131. The conduit 1500 is coupled to the hand unit 1200 via the coupling features 1530 and 1230 as described above and is in fluid communication with the channel 1240. The Dome 100′ is integrated with the conduit 1500, forming a unitary piece. This configuration allows liquid and/or air to flow from the base unit, through the tube 1131, into the channel 1240 in the hand unit and then through the hollow conduit 1500, to the Dome 100, and flush through the interface micro-gaps to a target tooth.

FIG. 13C shows an alternative form of the hand unit 1200′, which contains a channel 1240′, a battery chamber 1250′, an ultrasonication vibrator 1260′, a circuit board 1270′, and a control 1280′, with an arrangement different from the components in hand unit 1200. For example, the channel 1240 in the hand unit 1200 is positioned along one side 1293 of the hand unit, running from the top edge 1291 to the bottom edge 1292 of the hand unit (see FIG. 13B). The channel 1240′ in the hand unit 1200′ is sandwiched in between the ultrasonication vibrator 1260′ and the circuit board 1270′, running from a top edge 1251′ of the battery chamber 1250′ extending to a point 1241′ that aligns with the top edge 1261′ of the ultrasonication vibrator. Although not shown in FIGS. 13B and 13C, the hand unit 1200 and 1200′ may be modified to include an output display, and/or to remove the battery chamber and include a cord instead for plugging into a power supply.

FIG. 12 shows an alternative embodiment of the system 1000′, which includes a base unit 1100′, a hand unit 1200′, a conduit 1500′, and a Dome 100″′'. The Dome 100″″is detachably attached to the hand unit 1200′ via the conduit 1500′. The hand unit is in fluid communication with a tank 1120′ of the base unit 1100′ via a tube 1130′. The components and the configuration of the base unit are different from those in system 1000. For example, in addition to the tank 1120′, the tube 1130′, and a motor (not visible in FIG. 12), the base unit 1100′ also includes a pump, a switch, and optionally a pressure regulator (all of which are not visible in FIG. 12). The pump controls the pressure, pulse frequency, and/or velocity of the liquid flow, as well as the generation of vibration at the Dome. When the pump is coupled with a pressure regulator in the system, these operation parameters can be adjusted based on a user's needs. The switch included in the base unit is electrically connected to the pump, and thereby allows the pump and/or motor to be turned on and off. The tank 1120′ includes a drug inlet port 1600 located on the lid of the tank to allow a user to add drug tablet or liquid into the liquid inside the tank. Additionally, base unit 1100′ can include a power plug or a power cord 1802 that includes a power plug to allow the system to electrically connect with an external power source 1800 to provide sufficient power to the system.

1. A Dome for removing dental plaque/oral biofilms from a target surface or all surfaces of a tooth, comprising:
a socket head,
a socket ball, and
a pair of opposing bilateral wings,
wherein the socket head comprises two wing-connecting membranes and a top,
wherein the top comprises at least one set of opposite sides and an opening located at or near the center of the top,
wherein the two wing-connecting membranes are bonded to the set of opposite sides of the top,
wherein the wing-connecting membranes and top form a joint housing,
wherein the socket ball comprises a head portion and a connecting portion,
wherein the head portion is positioned inside the joint housing,
wherein the connecting portion passes through the opening ofin the top,
wherein each of the bilateral wings is bonded to the proximal end of one of the wing-connecting membranes via a connecting edge.

2. The Dome of claim 1, wherein each of the wing-connecting membranes comprises an inside surface and an outside surface, wherein a gap is positioned between a majority of the surface of the socket ball and the inside surface of each of the wing-connecting membranes.

3. The Dome of claim 1, wherein each of the bilateral wings extends downwardly from the wing-connecting membrane to which it is bonded.

4. The Dome of claim 1, wherein an open region is located in a joining area that joins each of the bilateral wings and the wing-connecting membrane to which it is bonded.

5. The Dome of claim 1, wherein each of the bilateral wings comprises a cleaning membrane, a base portion, and two side portions, wherein the base portion is connected to the cleaning membrane via a bottom edge and the side portions are connected to the cleaning membrane via a pair of opposite side edges.

6. The Dome of claim 5, wherein the cleaning membrane of each of the bilateral wings comprises an inside surface and an outside surface, wherein the outside surfaces of the cleaning membranes of the bilateral wings have a curvature such that the bilateral wings enclose each target tooth when in use.

7. The Dome of claim 6, wherein the inside surface of the cleaning membrane comprises a vertical plane that has a curvature that conforms to the external curvature of one or more types of teeth.

8. The Dome of claim 7, wherein the inside surface of the cleaning membrane comprises two or more vertical planes aligned side-by-side, wherein each vertical plane of the two or more vertical planes, has a curvature that conforms to the external curvature of one or more types of—The Dome of claim 7, wherein each of the base portion and two side portions has a curved shape such that is rolls away from the position of the periodontal tissues when in use.

9. The Dome of claim 5, wherein at least the bilateral wings comprises at least one cleaning element incorporated into the inside surface of the cleaning membrane.

10. The Dome of claim 5, wherein at least one of the bilateral wings comprises at least one cleaning element incorporated into the inside surface of the cleaning membrane.

11. The Dome of paragraph 10, wherein each water cannon of the plurality of water cannons comprises a hollow gun barrel, wherein the hollow gun barrel is embedded in the inside surface of the cleaning membrane, creating an opening thereonclaim 5 wherein the at least one of the bilateral wings comprises at least one cleaning element is incorporated into a base of the cleaning membrane.

12. The Dome of claim 10, wherein the at least one cleaning element is a plurality of at least one of water cannons, water cannon folds or a plurality of mega-nipples, a plurality of micro-nipples, or a plurality of water cannons coupled with mega-/micro-nipple heads.

13. The Dome of claim 13, wherein the hollow gun barrel has a tapered cylindrical shape.

14. The Dome of claim 12, wherein the water cannon fold or each water cannon fold of the two or more water cannon folds comprises a continuous channel along the bottom edge of the cleaning membrane.

15. The Dome of claim 16, wherein the channel comprises an opening positioned at an angle pointing at the periodontal pocket, wherein the channel has a depth sufficient to trap liquid/air and/or bubbles when in use.

16. The Dome of claim 15, wherein the two or more water cannon folds are arranged in parallel with each other with a suitable distance in between neighboring water cannon folds.

17. The Dome of claim 12, wherein each mega-nipple of the plurality of mega-nipples and/or each micro-nipple of the plurality of micro-nipples comprises a semi-spherical cone that protrudes from the inside surface of the cleaning membrane.

18. The Dome of claim 12, wherein each mega-nipple of the plurality of mega-nipples has a diameter in a range from >1 mm to about 5 mm, from about 1.2 mm to about 5 mm, from about 1.5 mm to about 3 mm, such as about 1.5 mm, from about 0.5 mm to about 1 mm, or from about 1 mm to about 2 mm;, each micro-nipple of the plurality of micro-nipples has a diameter in a range from about 0.1 mm to about 1 mm, from about 0.1 mm to about 0.8 mm, or from about 0.2 mm to about 0.6 mm, such as about 0.5 mm.

19. A system for removing dental plaque/oral biofilms from a target surface or all surfaces of a tooth, comprising:
the Dome of claim 1,
a conduit, and
a hand unit,
wherein the hand unit comprises a channel and two opposing ends,
wherein the dome is attached to one of the opposing ends of the hand unit via the conduit, and
wherein the channel of the hand unit is in fluid communication with a liquid and/or air source, and is in fluid communication with the conduit and the dome.

20. The system of claim 22, wherein the dome is integral with or detachably attaches to the conduit, and/or wherein the conduit is integral with or detachably attaches to the hand unit.

21. The system of claim 22, wherein the hand unit further comprises a chamber for a battery, gripping structures, an output display, or an audio component, or a combination thereof.

22. The system of claim 22, wherein the hand unit further comprises an ultrasonication vibrator, a circuit board, or a control, or a combination thereof.

23. The system of claim 22, further comprising a base unit, wherein the base unit comprises a tank and a tube, wherein the other opposing end of the hand unit is connected to the tank via the tube such that the channel of the hand unit is in fluid communication with a liquid inside the tank.

24. The system of claim 26, wherein the base unit further comprises an air channel configured to be in fluid communication with the channel of the hand unit via the tube.

25. The system of claim 26, wherein the base unit further comprises a motor and a pump, and optionally a pressure regulator, a power switch, a charging port, a tubing storage element, a stand for holding an additional conduit, and/or a water feeding element.

26. The system of claim 26, wherein the base unit further comprises a power port or a power cord configured to connect the system to an external power source.

27. The system of claim 26, wherein the tank comprises a body defined by a wall or two or more walls, and a lid, wherein the lid is integral with or detachably attaches to the body.

28. The system of claim 30, wherein the tank further comprises a drug inert port configured to allow addition of a drug table or a drug solution into the tank, wherein the drug inert port is located on the lid of the tank.

29. A method for oral cleaning in a subject in need thereof using the system of claim 22, comprising:
(i) moving the Dome along the dental arch of the subject.

30. The method of claim 32, wherein during step (i), liquid and/or air are ejected through an outlet of the socket ball of the Dome at a pressure in a range from about 0.5 psi to about 30 psi, at a pulse frequency in a range from about 0.5 Hz to about 50 Hz, and/or at a delivery pulse volume in a range from about 0.1 mL to about 150 mL.

31. The method of claim 32, further comprising providing an ultrasonic vibration to the Dome prior to and/or during step (i), wherein the ultrasonic vibration has a frequency in a range from about 100 to about 5000 vibrations per second, from about 500 to about 4000 vibrations per second, or from about 1000 to about 3000 vibrations per second.

32. The method of claim 32, further comprising attaching the Dome onto the conduit and/or hand unit prior to step (i); placing the Dome over a tooth of the subject prior to step (i); activating the power of the hand unit prior to or subsequent to step (i); selecting or adjusting the power output, duration of cleaning, frequency of ultrasonic vibration, and/or duration of ultrasonic vibration prior to or during step (i); maintaining the Dome over a target tooth for a period of time; switching between liquid and air during step (i);
and/or rinsing mouth with a mouthwash prior to and/or subsequent to step (i).
